(19) United States
(12) Patent Application Publication
(10) Pub. No.: US 2024/0092393 A1
(43) Pub. Date: Mar. 21, 2024

(54) SYSTEM FOR TRANSPORTING OBJECT TO BE TRANSPORTED, METHOD FOR TRANSPORTING OBJECT TO BE TRANSPORTED, PROGRAM FOR TRANSPORTING OBJECT TO BE TRANSPORTED, STORAGE MEDIUM, AND HARMFULNESS DETERMINATION DEVICE

(71) Applicant: HONDA MOTOR CO., LTD., Tokyo (JP)

(72) Inventor: Tatsuya HATTORI, Saitama (JP)

(73) Assignee: HONDA MOTOR CO., LTD., Tokyo (JP)

(21) Appl. No.: 18/276,148

(22) PCT Filed: Feb. 8, 2022
(86) PCT No.: PCT/JP2022/004967

§ 371 Date: Aug. 7, 2023

(30) Foreign Application Priority Data
Feb. 8, 2021 (JP) 2021-018508

(51) Int. Cl. B60W 60/00; G06Q 10/0832

(52) U.S. Cl. CPC B60W 60/0016; G06Q 10/0832; B60W 2540/221

(57) ABSTRACT

A system (1) for transporting an object (10) to be transported that is loaded on a first mobile unit (20) at a first point P1 comprises a harmfulness determination unit (53) that determines the degree of harmfulness of the object (10) to be transported that is loaded on the first mobile unit (20) to living organisms.

### TECHNICAL FIELD

The present invention relates to a system for transporting an object, a method for transporting an object, a program for transporting an object, a storage medium storing program for transporting an object, and a harmfulness determination device.

### BACKGROUND ART

In a related art, there has been a system for transporting an object that transports an object loaded in a moving body at a first point to a second point. For example, Patent Literature 1 discloses a transporting system that transporting an object such as a package loaded in an energy storage device from a first station to a second station. In the transporting system described in Patent Literature 1, the energy storage device can move autonomously, and it is possible to transport the object such as a package from the first station to the second station without manual intervention.

Incidentally, in recent years, infection spread of infectious diseases caused by new viruses and bacteria, and spread of radioactive substances are becoming social problems, and it is required to prevent contact with a harmful factor such as a virus, a bacterium, and a radioactive substance, and to prevent the spread of the harmful factor.

Therefore, Patent Literature 2 discloses an infectious disease information providing system and method that enables information on a status in which persons are infected with an epidemic infectious disease to be used when a user searches for an itinerary using a navigation system before actually taking action. According to the infectious disease information providing system and method described in Patent Literature 2, the itinerary that avoids a region where there is a risk of contact with an infected person can be provided to a mobile terminal.

Further, by applying the infectious disease information providing system described in Patent Literature 2 to the transporting system described in Patent Literature 1, the object can be transported from the first station to the second station in the itinerary in which the object loaded in the moving body does not come into contact with the harmful factor, and thus the object and the moving body can be prevented from coming into contact with the harmful factor during movement from the first station to the second station.

### CITATION LIST

### Patent Literature

Patent Literature 1: WO2020/203929
Patent Literature 2: JP2011-191236A

### SUMMARY OF INVENTION

### Technical Problem

However, even if the infectious disease information providing system described in Patent Literature 2 is applied to the transporting system described in Patent Literature 1, it is difficult to prevent the harmful factor from spreading through a medium of the object when the object adheres to the harmful factor.

The present invention provides a system for transporting an object, a method for transporting an object, a program for transporting an object, a storage medium storing a program for transporting an object, and a harmfulness determination device which can prevent a harmful factor from spreading through a medium of the object.

### Solution to Problem

The present invention relates to a system for transporting an object that transports an object loaded in a moving body at a first point, and the system includes:
a harmful degree determination unit configured to determine a harmful degree to a living organism of the object loaded in the moving body.

The present invention relates to a method for transporting an object loaded in a moving body at a first point, and the method includes:
a transport object state acquisition step of acquiring transport object state information which is information on a state of the object loaded in the moving body; and
a harmful degree determination step of determining a harmful degree to a living organism of the object loaded in the moving body based on the transport object state information acquired in the transport object state acquisition step.

The present invention relates to a program for transporting an object loaded in a moving body at a first point, and the program is configured to execute:
a transport object state acquisition process of acquiring transport object state information which is information on a state of the object loaded in the moving body; and
a harmful degree determination process of determining a harmful degree to a living organism of the object loaded in the moving body based on the transport object state information acquired in the transport object state acquisition process.

The present invention relates to a harmfulness determination device including: a harmful degree determination unit configured to determine a harmful degree to a living organism of an transport object loaded in a moving body at a first point.

### Advantageous Effects of Invention

According to the present invention, since it is possible to determine a harmful degree of a transport object to a living organism, it is possible to prevent a harmful factor from spreading through a medium of the transport object when there is the harmful factor in the transport object.

### BRIEF DESCRIPTION OF DRAWINGS

FIG. 1 is a schematic diagram of a system for transporting an object according to a first embodiment of the present invention.

FIG. 2 is a flowchart (part 1) of a processing operation of the system in FIG. 1.

FIG. 3 is a flowchart (part 2) of the processing operation of the system in FIG. 1.

FIG. 4 is a flowchart of a harmful degree determination process in the system in FIG. 1.

FIG. 5 is a diagram illustrating a harmful degree determination table of a harmful degree determination unit in the system in FIG. 1.

FIG. 6 is a flowchart of a transport plan creation process in the system in FIG. 1.

FIG. 7 is a schematic diagram of a system for transporting an object according to a second embodiment of the present invention.

FIG. 8 is a flowchart of a transport plan creation process in the system in FIG. 7.

FIG. 9 is a schematic diagram of a system for transporting an object according to a third embodiment of the present invention.

FIG. 10 is a flowchart (part 1) of a processing operation of the system in FIG. 9.

FIG. 11 is a flowchart (part 2) of the processing operation of the system in FIG. 9.

FIG. 12 is a flowchart (part 3) of the processing operation of the system in FIG. 9.

FIG. 13 is a flowchart of a harmed degree determination process in the system in FIG. 9.

FIG. 14 is a flowchart of a transport plan creation process in the system in FIG. 9.

### DESCRIPTION OF EMBODIMENTS

Hereinafter, embodiments of a system for transporting an object according to the present invention will be described with reference to the accompanying drawings.

### First Embodiment

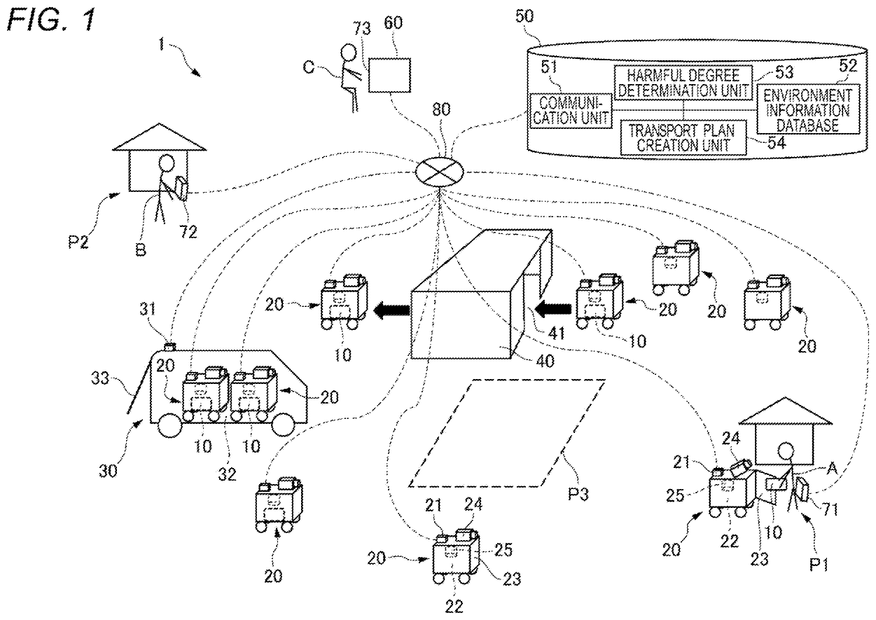

First, a system 1 for transporting an object according to a first embodiment of the present invention will be described with reference to FIGS. 1 to 6.

<Overall Configuration of System for Transporting Object>

As illustrated in FIG. 1, the system 1 according to the present embodiment includes transport objects 10, first moving bodies 20, a second moving body 30, a disinfection station 40, a server 50, a system management terminal 60, a first notification unit 71, a second notification unit 72, and a third notification unit 73. The system 1 is a system capable of transporting, to a second point P2, the object 10 loaded in the first moving body 20 at a first point P1. The system 1 includes the plurality of first moving bodies 20, and is capable of transporting the plurality of objects 10 by the plurality of first moving bodies 20. Further, each of the first moving bodies 20 may be capable of transporting the plurality of objects 10 to different transport destinations. The system 1 may include a plurality of the second moving bodies 30.

The first moving bodies 20, the second moving body 30, the disinfection station 40, the server 50, the system management terminal 60, the first notification unit 71, the second notification unit 72, and the third notification unit 73 are connected to a communication network 80. The communication network 80 is not particularly limited, and is, for example, the Internet.

The object 10 is loaded in the first moving body 20 by a sender A at the first point P1. In the present embodiment, the object 10 is a package such as an article. The object 10 loaded in the first moving body 20 by the sender A at the first point P1 and transported to the second point P2 can be received by a receiver B at the second point P2.

The first moving body 20 is a self-propelled unmanned vehicle traveling on a road by wheels. An energy storage device (not shown) is mounted on the first moving body 20, and the first moving body 20 travels using energy stored in the energy storage device as a drive source.

The first moving body 20 includes a communication unit 21. The communication unit 21 includes, for example, a network adapter or the like, and transmits and receives various data to and from other devices via the communication network 80. The first moving body 20 can receive a movement command from the server 50 via the communication network 80 by the communication unit 21. The first moving body 20 automatically runs based on the movement command received from the server 50. Further, the first moving body 20 can transmit information such as position information and a moving state of the first moving body 20, an energy storage state of the energy storage device mounted on the first moving body 20, the presence or absence of loading of the object 10, and a loading time of the object 10 loaded in the past from the communication unit 21 to the server 50 via the communication network 80.

The first moving body 20 includes an accommodating portion 22 capable of accommodating the object 10 therein. The first moving body 20 further includes an openable and closable swing door 23, and when the swing door 23 is in an open state, the object 10 can enter the accommodating portion 22 from an outside of the first moving body 20. Therefore, by bringing the swing door 23 into the open state, the sender A can put the object 10 in the accommodating portion 22 from the outside of the first moving body 20.

The first moving body 20 is equipped with a sender state acquisition unit 24. The sender state acquisition unit 24 acquires information on a state of the sender A when the object 10 is loaded in the first moving body 20 by the sender A at the first point P1. The information on the state of the sender A includes a health condition of the sender A, such as a body temperature, a blood pressure, a blood flow, blood oxygen, the presence or absence of a cough, the presence or absence of a complexion abnormality, the presence or absence of infection of a virus, a bacterium, or the like, a movement history, an action history, contact information, and the like of the sender A. The sender state acquisition unit 24 may be, for example, a camera, a microphone, a speaker, a hemomanometer, or the like, or may be a detection device that detects a gene sequence or a protein of a virus, a bacterium, or the like. Further, the sender state acquisition unit 24 may be an information terminal that can be input by the sender A, which includes a display device, and may acquire information on the state of the sender A based on information input by the sender A with respect to a question item displayed on the display device. The information on the state of the sender A acquired by the sender state acquisition unit 24 can be transmitted to the server 50. The sender state acquisition unit 24 includes a transmission unit (not shown), and the information on the state of the sender A acquired by the sender state acquisition unit 24 may be transmitted from the transmission unit to the server 50. Further, the information on the state of the sender A acquired by the sender state acquisition unit 24 may be transmitted from the communication unit 21 of the first moving body 20 to the server 50.

The first moving body 20 is equipped with a transport object state acquisition unit 25. For example, the transport object state acquisition unit 25 is disposed inside the accommodating portion 22. The transport object state acquisition unit 25 acquires information on a state of the object 10 loaded in the first moving body 20. The information on the state of the object 10 is, for example, the presence or absence of adhering of a virus, a bacterium, or the like, a movement history, contact information of the object 10, and the like. The transport object state acquisition unit 25 may be, for example, a sensor device including a light emitting element capable of emitting ultraviolet rays or infrared rays and an image pickup element, or may be a detection device that detects a gene sequence or a protein of a virus, a bacterium, or the like. The information on the state of the object 10 acquired by the transport object state acquisition unit 25 can be transmitted to the server 50 via the communication network 80. The transport object state acquisition unit 25 includes a transmission unit (not shown), and the information on the state of the object 10 acquired by the transport object state acquisition unit 25 may be transmitted from the transmission unit to the server 50 via the communication network 80. Further, the information on the state of the object 10 acquired by the transport object state acquisition unit 25 may be transmitted from the communication unit 21 of the first moving body 20 to the server 50 via the communication network 80.

Accordingly, even during movement of the first moving body 20, the information on the state of the object 10 loaded in the first moving body 20 can be acquired.

The second moving body 30 is a vehicle traveling on the road by wheels. The second moving body 30 may be a self-propelled unmanned vehicle or a vehicle that moves according to an operation of a driver on board.

The second moving body 30 includes a communication unit 31. The communication unit 31 includes, for example, a network adapter or the like, and transmits and receives various data to and from other devices via the communication network 80. The second moving body 30 may receive, by the communication unit 31, the movement command from the server 50 via the communication network 80, and may be self-propelled based on the movement command received from the server 50. Further, the second moving body 30 can transmit information such as position information and a moving state of the second moving body 30, an accommodation situation of the first moving body 20, and the like from the communication unit 31 to the server 50 via the communication network 80.

In the present embodiment, the second moving body 30 includes an accommodating portion 32 in which the plurality of first moving bodies can be accommodated. The second moving body 30 further includes an openable and closable swing door 33, and when the swing door 33 is in an open state, the first moving body 20 can enter the accommodating portion 32 from an outside of the second moving body 30.

The disinfection station 40 includes a disinfection chamber 41 capable of accommodating the object 10 loaded in the first moving body 20 and the first moving body 20. In the disinfection station 40, the first moving body 20 accommodated in the disinfection chamber 41 and the object 10 loaded in the first moving body 20 can be disinfected. For example, in the disinfection station 40, when the first moving body 20 is accommodated in the disinfection chamber 41, the swing door 23 is opened to be in the open state. Then, a disinfectant is sprayed into an interior of the disinfection chamber 41, and harmful factors such as a virus and a bacterium adhering to the first moving body 20 accommodated in the disinfection chamber 41 and the object 10 loaded in the first moving body 20 are disinfected. In the disinfection station 40, by irradiating the interior of the disinfection chamber 41 with the ultraviolet rays, the harmful factors such as a virus and a bacterium adhering to the first moving body 20 accommodated in the disinfection chamber 41 and the object 10 loaded in the first moving body 20 may be disinfected.

The server 50 includes a communication unit 51, an environment information database 52, a harmful degree determination unit 53, and a transport plan creation unit 54.

The communication unit 51 includes, for example, a network adapter or the like, and transmits and receives various data to and from other devices via the communication network 80.

The environment information database 52 stores map information, infectious disease epidemic information, weather information, traffic congestion information, and the like. The map information can be acquired from Geographical Survey Institute, a map producing company, or the like. The infectious disease epidemic information is information indicating an epidemic degree of the infectious disease, and is infectious disease patient information that can be acquired from National Institute of Infectious Diseases, a local government, a group in which a plurality of hospitals participate, or the like. The weather information is information indicating a temperature, humidity, and weather of each place, and can be acquired from a Meteorological Agency, a weather information company, or the like. The traffic congestion information is information indicating a congestion situation caused by people, and can be acquired from a transportation infrastructure-related company, an information terminal mounted on a moving body such as a vehicle, a personal digital assistant, and the like.

The harmful degree determination unit 53 determines a harmful degree of the object 10 loaded in the first moving body 20 to a living organism based on the information on the state of the sender A acquired by the sender state acquisition unit 24, the information on the state of the object 10 acquired by the transport object state acquisition unit 25, and various information stored in the environment information database 52. In the present embodiment, an infection risk of the infectious disease caused by the virus, the bacterium, and the like, to persons through a medium of the object 10 loaded in the first moving body 20 is determined as the harmful degree of the object 10 loaded in the first moving body 20 to the living organism. Details of the determination of the harmful degree to the living organism of the object 10 loaded in the first moving body 20 in the harmful degree determination unit 53 will be described later.

Accordingly, since the system 1 can determine the harmful degree of the object 10 to the living organism, when there is the harmful factor in the object 10, it is possible to prevent the harmful factor from spreading through the medium of the object 10.

Accordingly, since the harmful degree determination unit 53 determines the harmful degree to the living organism of the object 10 loaded in the first moving body 20 based on the information on the state of the sender A acquired by the sender state acquisition unit 24, it is possible to accurately determine the harmful degree of the object 10.

The harmful degree determination unit 53 determines the harmful degree of the first moving body 20 to the living organism. In the present embodiment, the infection risk of the infectious disease caused by the virus, the bacterium, or the like to the persons through a medium of the first moving body 20 is determined as the harmful degree of the first moving body 20 to the living organism based on the harmful degree to the living organism of the object 10 loaded in the first moving body 20, the loading time of the object 10 loaded in the first moving body 20, the movement history of the first moving body 20, and the various information stored in the environment information database 52.

Accordingly, the system 1 can determine the infection risk to the living organism of the object 10 which is an infection source.

Furthermore, since the system 1 can determine the harmful degree of the first moving body 20 to the living organism, it is possible to prevent the harmful factor from spreading through the medium of the first moving body 20 when there is the harmful factor in the first moving body 20.

The transport plan creation unit 54 creates a transport plan for the object 10 based on the various information stored in the environment information database 52 and the harmful degree of the object 10 determined by the harmful degree determination unit 53. In the present embodiment, the transport plan creation unit 54 creates the transport plan for the object 10 based on the various information stored in the environment information database 52 and the infection risk of the infectious disease caused by the virus, the bacterium, and the like to the persons through the medium of the object 10, which is determined by the harmful degree determination unit 53. The details of the creation of the transport plan for the object 10 in the transport plan creation unit 54 will be described later.

Accordingly, the system 1 can create the transport plan for the object 10 based on the harmful degree of the object 10 determined by the harmful degree determination unit 53, and thus the system 1 can create the transport plan for preventing the harmful factor from spreading through the medium of the object 10 when there is the harmful factor in the object 10.

The transport plan creation unit 54 further creates a movement plan for the first moving body 20 based on the created transport plan. Further, the movement command of the first moving body 20 based on the movement plan for the first moving body 20 created by the transport plan creation unit 54 is transmitted from the communication unit 51 to the communication unit 21 of the first moving body 20 via the communication network 80, and the first moving body 20 autonomously moves based on the received movement command.

The system management terminal 60 is an information terminal that manages the first moving body 20, the second moving body 30, the disinfection station 40, and the server 50 via the communication network 80. The system management terminal 60 is operated by a system administrator C who is an administrator of the system 1.

The first notification unit 71 notifies the sender A of the information. The first notification unit 71 is, for example, a display screen displayed on a display device of a personal digital assistant such as a smartphone owned by the sender A. The first notification unit 71 notifies the sender A of at least a part of the transport plan for the object 10 created by the transport plan creation unit 54. Further, when the harmful degree of the object 10 determined by the harmful degree determination unit 53 is equal to or greater than a predetermined threshold value, the first notification unit 71 notifies the sender A of a determination result of the harmful degree determination unit 53 or information indicating that the harmful degree of the object 10 is equal to or greater than the predetermined threshold value.

The second notification unit 72 notifies the receiver B of the information. The second notification unit 72 is, for example, a display screen displayed on a display of a personal digital assistant such as a smartphone owned by the receiver B. The second notification unit 72 notifies the receiver B of at least a part of the transport plan for the object 10 created by the transport plan creation unit 54. Further, when the harmful degree of the object 10 determined by the harmful degree determination unit 53 is equal to or greater than the predetermined threshold value, the second notification unit 72 notifies the receiver B of the determination result of the harmful degree determination unit 53 or the information indicating that the harmful degree of the transport object 10 is equal to or greater than the predetermined threshold value.

The third notification unit 73 notifies the system administrator C of the information. The third notification unit 73 is, for example, a display screen displayed on a display device of the system management terminal 60. The third notification unit 73 notifies the system administrator C of at least a part of the transport plan for the object 10 created by the transport plan creation unit 54.

<Processing Operation of Conveyance Object Conveying System>

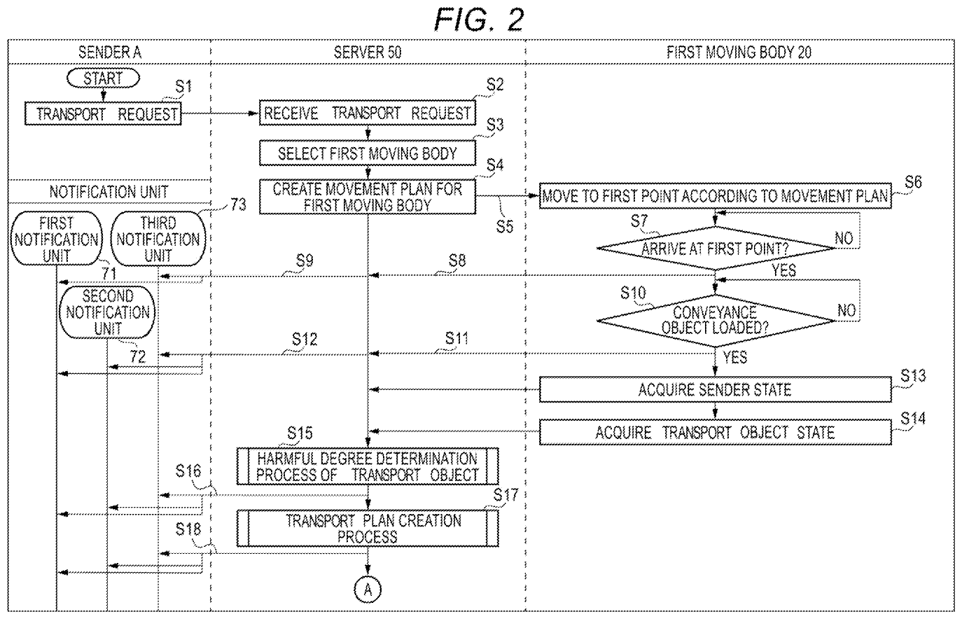

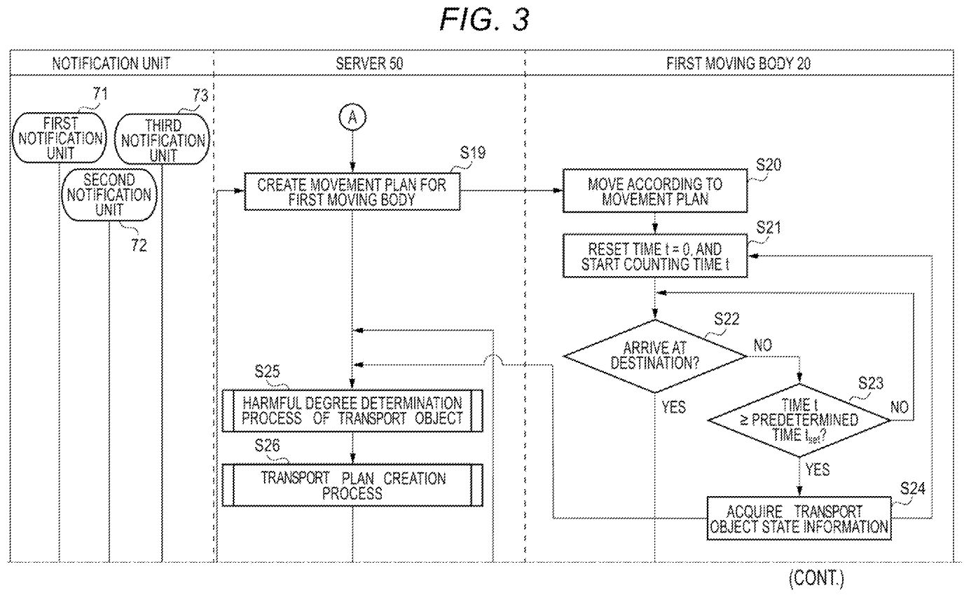

Next, a processing operation of the system 1 configured as described above will be specifically described with reference to FIGS. 2 to 6.

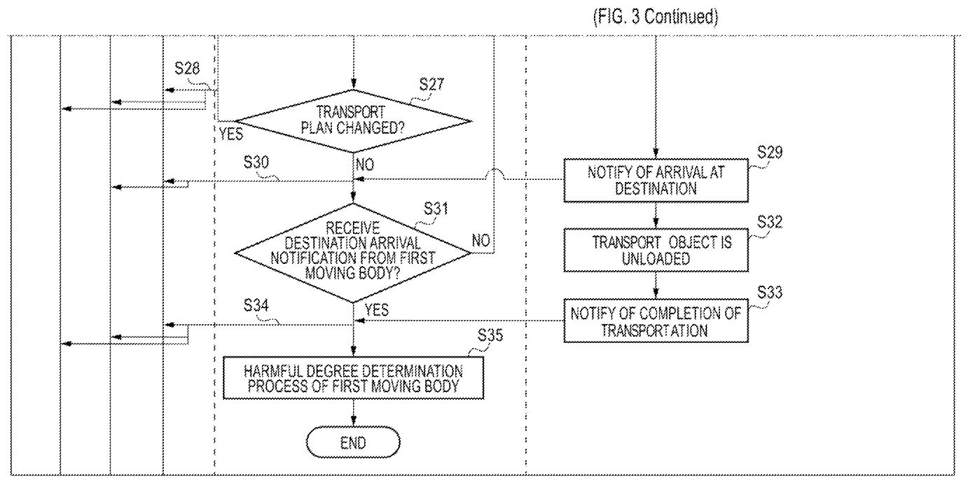

As shown in FIGS. 2 and 3, first, when the sender A makes a transport request of the object 10 (step S1), the server 50 receives the transport request of the object 10 from the sender A (step S2). The transport request is performed by, for example, operating the personal digital assistant owned by the sender A by an application program stored in the personal digital assistant owned by the sender A, thereby transmitting a transport request signal to the server 50 via the communication network 80. The server 50 receives, for example, the transport request signal via the communication network 80, thereby receiving the transport request of the object 10 from the sender A.

When the server 50 receives the transport request of the object 10 from the sender A, the server 50 selects the first moving body 20 to be moved to the first point P1 based on the various information stored in the environment information database 52, various information such as position information and a moving state transmitted from each of the first moving bodies 20, an energy storage state of the mounted energy storage device, the presence or absence of the loading of the object 10, and a loading time of the object 10 loaded in the past, and the harmful degree of each of the first moving bodies 20 acquired in a harmful degree determination process of the first moving body 20 to be described later (step S3). Hereinafter, among the plurality of first moving bodies 20, the first moving body 20 selected in step S3 is referred to as the first moving body 20.

Subsequently, the server 50 creates a movement plan for the first moving body 20 to the first point P1 based on the various information stored in the environment information database 52, and the various information such as position information and a moving state transmitted from the first moving body 20, an energy storage state of the mounted energy storage device, and the presence or absence of the loading of the object 10 (step S4). Further, the server 50 transmits a movement instruction based on the created movement plan to the first moving body 20 (step S5).

The first moving body 20 that has received the movement instruction moves to the first point P1 according to the movement plan created by the server 50 (step S6).

The first moving body 20 determines whether the first moving body 20 has arrived at the first point P1 during the movement to the first point P1 (step S7), and when the first moving body 20 has not arrived at the first point P1 (step S7: NO), the first moving body 20 repeats step S7.

When the first moving body 20 arrives at the first point P1 (step S7: YES), the first moving body 20 transmits, to the server 50, information indicating that the first moving body 20 has arrived at the first point P1 (step S8), and the first moving body 20 proceeds to step S10.

When the server 50 receives the information indicating that the first moving body 20 has arrived at the first point P1, the server 50 transmits the information to the first notification unit 71 and the third notification unit 73 (step S9). When the first notification unit 71 receives the information indicating that the first moving body 20 has arrived at the first point P1, the first notification unit 71 notifies the sender A of the information indicating that the first moving body 20 has arrived at the first point P1, and when the third notification unit 73 receives the information indicating that the first moving body 20 has arrived at the first point P1, the third notification unit 73 notifies the system administrator C of the information indicating that the first moving body 20 has arrived at the first point P1. Accordingly, the sender A and the system administrator C can recognize that the first moving body 20 has arrived at the first point P1. The information may be transmitted from the first moving body 20 to the first notification unit 71 and the third notification unit 73 via the communication network 80 without passing through the server 50.

Since the sender A can recognize that the first moving body 20 has arrived at the first point P1 by the first notification unit 71, the sender A can load the object 10 into the first moving body 20 at the first point P1.

In step S10, the first moving body 20 determines whether the object 10 is loaded, and when the object 10 is not loaded (step S10: NO), the first moving body 20 repeats step S10.

When the object 10 is loaded (step S10: YES), the first moving body 20 transmits, to the server 50, information indicating that the object 10 is loaded (step S11), and the first moving body 20 proceeds to step S13.

When the server 50 receives the information indicating that the object 10 is loaded in the first moving body 20, the server 50 transmits the information to the first notification unit 71, the second notification unit 72, and the third notification unit 73 (step S12). When the first notification unit 71 receives the information indicating that the object 10 is loaded in the first moving body 20, the first notification unit 71 notifies the sender A of the information indicating that the object 10 is loaded in the first moving body 20, when the second notification unit 72 receives the information indicating that the object 10 is loaded in the first moving body 20, the second notification unit 72 notifies the receiver B of the information indicating that the object 10 is loaded in the first moving body 20, and when the third notification unit 73 receives the information indicating that the object 10 is loaded in the first moving body 20, the third notification unit 73 notifies the system administrator C of the information indicating that the object 10 is loaded in the first moving body 20. Accordingly, the sender A, the receiver B. and the system administrator C can recognize that the object 10 is loaded in the first moving body 20. The information may be transmitted from the first moving body 20 to the first notification unit 71, the second notification unit 72, and the third notification unit 73 via the communication network 80 without passing through the server 50.

In step S13, the first moving body 20 acquires, by the sender state acquisition unit 24, the information on the state of the sender A when the object 10 is loaded in the first moving body 20 by the sender A at the first point P1, and transmits the information to the server 50. Further, the process proceeds to step S14.

In step S14, the first moving body 20 acquires, by the object state acquisition unit 25, the information on the state of the object 10 loaded in the first moving body 20, and transmits the information to the server 50.

When the server 50 receives the information on the state of the sender A transmitted in step S13 and the information on the state of the object 10 loaded in the first moving body 20 transmitted in step S14, the server 50 executes the harmful degree determination process (step S15) of the object 10 and acquires a harmful degree H of the object 10 in the harmful degree determination unit 53. Details of the harmful degree determination process of the object 10 in step S15 will be described later.

In this way, in the harmful degree determination process, since the harmful degree of the object 10 is determined based on the information on the state of the sender A acquired in step S13, it is possible to more accurately determine the harmful degree of the transport object.

When the harmful degree determination process of the object 10 is completed in step S15, the server 50 transmits the information on the acquired harmful degree H of the object 10 to the first notification unit 71, the second notification unit 72, and the third notification unit 73 (step S16). The server 50 may transmit the acquired harmful degree H of the object 10 to the first notification unit 71, the second notification unit 72, and the third notification unit 73, or may transmit, to the first notification unit 71, the second notification unit 72, and the third notification unit 73, information indicating whether the acquired harmful degree H of the object 10 is equal to or greater than a third threshold value to be described later, is less than the third threshold value and equal to or greater than a second threshold value, is less than the second threshold value and is equal to or greater than a first threshold value, or is less than the first threshold value.

The first notification unit 71 notifies the sender A of a determination result of the harmful degree H of the object 10 in the harmful degree determination process performed by the harmful degree determination unit 53 based on the information on the harmful degree H of the object 10 received from the server 50 when the harmful degree H of the object 10 is equal to or greater than the predetermined threshold value, or information indicating that the harmful degree H of the object 10 is equal to or greater than the predetermined threshold value. In the present embodiment, when the harmful degree H of the object 10 received from the server 50 is equal to or greater than the third threshold value to be described later, the first notification unit 71 displays red as information indicating that the harmful degree H of the object 10 is equal to or greater than the third threshold value on the display screen indicating the harmful degree of the object 10. Further, when the harmful degree H of the object 10 received from the server 50 is less than the third threshold value and equal to or greater than the second threshold value, which will be described later, the first notification unit 71 displays orange as information indicating that the harmful degree H of the object 10 is less than the third threshold value and equal to or greater than the second threshold value on the display screen indicating the harmful degree of the object 10. When the harmful degree H of the object 10 received from the server 50 is less than the second threshold value and equal to or greater than the first threshold value, which will be described later, the first notification unit 71 displays yellow as information indicating that the harmful degree H of the object 10 is less than the second threshold value and equal to or greater than the first threshold value on the display screen indicating the harmful degree of the object 10. When the harmful degree H of the object 10 received from the server 50 is less than the first threshold value to be described later, the first notification unit 71 displays green as information indicating that the harmful degree H of the object 10 is less than the first threshold value on the display screen indicating the harmful degree of the object 10. When the harmful degree H of the object 10 received from the server 50 is equal to or greater than the predetermined threshold value, the first notification unit 71 may display the determination result of the harmful degree of the object 10 received from the server 50 on the display screen indicating the harmful degree of the object 10.

The second notification unit 72 notifies the receiver B of the determination result of the harmful degree of the object 10 in the harmful degree determination process performed by the harmful degree determination unit 53 based on the information on the harmful degree H of the object 10 received from the server 50 when the harmful degree H of the object 10 is equal to or greater than the predetermined threshold value, or the information indicating that the harmful degree H of the object 10 is equal to or greater than the predetermined threshold value. In the present embodiment, when the harmful degree H of the object 10 received from the server 50 is equal to or greater than the third threshold value to be described later, the second notification unit 72 displays red as the information indicating that the harmful degree H of the object 10 is equal to or greater than the third threshold value on the display screen indicating the harmful degree of the object 10. Further, when the harmful degree H of the object 10 received from the server 50 is less than the third threshold value and equal to or greater than the second threshold value, which will be described later, the second notification unit 72 displays orange as the information indicating that the harmful degree H of the object 10 is less than the third threshold value and equal to or greater than the second threshold value on the display screen indicating the harmful degree of the object 10. When the harmful degree H of the object 10 received from the server 50 is less than the second threshold value and equal to or greater than the first threshold value, which will be described later, the second notification unit 72 displays yellow as the information indicating that the harmful degree H of the object 10 is less than the second threshold value and equal to or greater than the first threshold value on the display screen indicating the harmful degree of the object 10. When the harmful degree H of the object 10 received from the server 50 is less than the first threshold value to be described later, the second notification unit 72 displays green as the information indicating that the harmful degree H of the object 10 is less than the first threshold value on the display screen indicating the harmful degree of the object 10. When the harmful degree H of the object 10 received from the server 50 is equal to or greater than the predetermined threshold value, the second notification unit 72 may display the determination result of the harmful degree of the object 10 received from the server 50 on the display screen indicating the harmful degree of the object 10.

The third notification unit 73 notifies the system administrator C of the determination result of the harmful degree of the object 10 in the harmful degree determination process performed by the harmful degree determination unit 53 based on the information on the harmful degree H of the object 10 received from the server 50 when the harmful degree H of the object 10 is equal to or greater than the predetermined threshold value, or the information indicating that the harmful degree H of the object 10 is equal to or greater than the predetermined threshold value. In the present embodiment, when the harmful degree H of the object 10 received from the server 50 is equal to or greater than the third threshold value to be described later, the third notification unit 73 displays red as the information indicating that the harmful degree H of the object 10 is equal to or greater than the third threshold value on the display screen indicating the harmful degree of the object 10. Further, when the harmful degree H of the object 10 received from the server 50 is less than the third threshold value and equal to or greater than the second threshold value, which will be described later, the third notification unit 73 displays orange as the information indicating that the harmful degree H of the object 10 is less than the third threshold value and equal to or greater than the second threshold value on the display screen indicating the harmful degree of the object 10. When the harmful degree H of the object 10 received from the server 50 is less than the second threshold value and equal to or greater than the first threshold value, which will be described later, the third notification unit 73 displays yellow as the information indicating that the harmful degree H of the object 10 is less than the second threshold value and equal to or greater than the first threshold value on the display screen indicating the harmful degree of the object 10. When the harmful degree H of the object 10 received from the server 50 is less than a first threshold value to be described later, the third notification unit 73 displays green as information indicating that the harmful degree H of the object 10 is less than the first threshold value on the display screen indicating the harmful degree of the object 10. When the harmful degree H of the object 10 received from the server 50 is equal to or greater than the predetermined threshold value, the third notification unit 73 may display the determination result of the harmful degree of the object 10 received from the server 50 on the display screen indicating the harmful degree of the object 10.

Accordingly, the sender A, the receiver B, and the system administrator C can recognize the determination result of the harmful degree of the object 10 in the harmful degree determination process performed by the harmful degree determination unit 53 when the harmful degree H of the object 10 is equal to or greater than the predetermined threshold value, and the information indicating that the harmful degree H of the object 10 is equal to or greater than the predetermined threshold value.

Subsequently, the server 50 proceeds to step S17, and executes the transport plan creation process (step S17) based on the harmful degree H of the object 10 acquired in step S15 in the transport plan creation unit 54 to create the transport plan for the object 10. In the present embodiment, the transport plan in which a destination and a through point of the object 10 are designated is created by the transport plan creation process (step S17). Further, in the present embodiment, the transport plan for the object 10 created by the transport plan creation process (step S17) includes a transport plan #1 in which the destination is set to the second point P2 and no through point is set, a transport plan #2 in which the destination is set to the second point P2 and the through point is set to the disinfection station 40, a transport plan #3 in which the destination is set to the disinfection station 40 and no through point is set, and a transport plan #4 in which the destination is set to a discard point P3 and no through point is set. Details of the transport plan creation process in step S17 will be described later.

Accordingly, the transport plan for the object 10 can be created based on the harmful degree of the object 10 acquired in the harmful degree determination process, and thus it is possible to create the transport plan for preventing the harmful factor from spreading through the medium of the object 10 when there is the harmful factor in the object 10.

When the transport plan creation process in step S17 is completed, the server 50 transmits the information on the created transport plan for the object 10 to the first notification unit 71, the second notification unit 72, and the third notification unit 73 (step S18). The server 50 may transmit the created transport plan for the object 10 to the first notification unit 71, the second notification unit 72, and the third notification unit 73, or may transmit, to the first notification unit 71, the second notification unit 72, and the third notification unit 73, information indicating whether the created transport plan for the object 10 is a plan for transporting the object 10 to the second point P2, a plan for aborting transporting of the object 10 to the second point P2, or a plan for discarding the object 10.

Accordingly, the sender A, the receiver B, and the system administrator C can recognize at least a part of the transport plan for the object 10 created by the transport plan creation unit 54.

Subsequently, the server 50 proceeds to step S19, and creates the movement plan for the first moving body 20 based on the transport plan for the object 10 created in the transport plan creation process in step S17 in the transport plan creation unit 54, the various information stored in the environment information database 52, the various information such as position information and a moving state transmitted from the first moving body 20, an energy storage state of the mounted energy storage device, the presence or absence of the loading of the object 10, and a loading time of the object 10 loaded in the past, and various information such as position information and a moving state of the second moving body 30 transmitted from the second moving body 30, and the accommodation situation of the first moving body 20.

For example, based on the infectious disease epidemic information stored in the environment information database 52 and the position information transmitted from the first moving body 20, the movement plan for the first moving body 20 may be created so as to obtain a path for avoiding a region in which the infectious disease is epidemic. Further, based on the position information transmitted from the first moving body 20, energy storage state information of the mounted energy storage device, and the position information and the moving state information of the second moving body 30 transmitted from the second moving body 30, the server 50 determines whether the first moving body 20 moves while being accommodated in the second moving body 30, and creates the movement plan for the first moving body 20. Further, the server 50 may determine, according to the created transport plan for the object 10, whether the first moving body 20 is accommodated in the second moving body 30 and moves, and create the movement plan for the first moving body 20. For example, in the case in which the created transport plan is the transport plan #3 or the transport plan #4 described above, since the harmful degree H of the object 10 is high, the server 50 may create the movement plan for the first moving body 20 such that the first moving body 20 is not accommodated in the second moving body 30, and in the case in which the created transport plan is the transport plan #2 described above, the server 50 may create the movement plan for the first moving body 20 such that the first moving body 20 moves without being accommodated in the second moving body 30 on a route to the disinfection station 40 and moves while being accommodated in the second moving body 30 after passing through the disinfection station 40.

Accordingly, it is possible to create the movement plan for the first moving body 20 so as to prevent the harmful factor such as a virus or a bacterium from spreading through the medium of the object 10, based on the transport plan created by the transport plan creation unit 54.

The server 50 transmits, to the first moving body 20, the movement plan for the first moving body 20 created in step S19 in the transport plan creation unit 54. When the first moving body 20 receives the movement plan for the first moving body 20 from the server 50, the first moving body 20 starts moving toward the through point or the destination according to the received movement plan for the first moving body 20 (step S20).

When the first moving body 20 starts moving toward the through point or the destination according to the received movement plan for the first moving body 20 (step S20), the first moving body 20 resets a time t of a mounted timer to zero, and starts counting the time t (step S21).

Subsequently, the first moving body 20 determines whether the first moving body 20 has arrived at the destination (step S22). When the first moving body 20 has not arrived at the destination (step S22: NO), the first moving body 20 determines whether the time t of the timer has passed a predetermined time tₛₑₜ or more set in advance (step S23). When the time t of the timer has not passed the predetermined time tₛₑₜ in advance (step S23: NO), the process returns to step S22. When the time t of the timer has passed the predetermined time tₛₑₜ in advance (step S23: YES), the process proceeds to step S24, and the transport object state acquisition unit 25 acquires the information on the state of the object 10 loaded in the first moving body 20 and transmits the information to the server 50.

When the first moving body 20 acquires, by the transport object state acquisition unit 25, the information on the state of the object 10 loaded in the first moving body 20 and transmits the information to the server 50 (step S24), and the process returns to step S21.

In this way, during the movement from the first point P1 to the destination, the first moving body 20 acquires, by the transport object state acquisition unit 25, the information on the state of the object 10 loaded in the first moving body 20 every predetermined time tₛₑₜ, and transmits the information to the server 50.

After the movement plan for the first moving body 20 is created in step S19, when the server 50 receives the information on the state of the object 10 loaded in the first moving body 20 from the first moving body 20 in step S24, the server 50 executes the harmful degree determination process (step S25) of the object 10 in the harmful degree determination unit 53 based on the information on the state of the sender A received in step S13 and the information on the state of the object 10 loaded in the first moving body 20 received in step S24 upon the receipt of the information, and acquires the harmful degree H of the object 10. The harmful degree determination process of the object 10 in step S25 is the same as the process in step S15 described above.

Accordingly, even when the harmful degree H of the object 10 loaded in the first moving body 20 changes during the movement of the first moving body 20, it is possible to appropriately determine the harmful degree of the object 10.

Subsequently, the server 50 proceeds to step S26, and executes the transport plan creation process (step S26) based on the harmful degree H of the object 10 acquired in step S25 in the transport plan creation unit 54 to create the transport plan for the object 10. The transport plan creation process in step S26 is the same as the transport plan creation process in step S17, and the transport plan for the object 10 created by the transport plan creation process in step S26 includes a transport plan #1 in which the destination is set to the second point P2 and no through point is set, a transport plan #2 in which the destination is set to the second point P2 and the through point is set to the disinfection station 40, a transport plan #3 in which the destination is set to the disinfection station 40 and no through point is set, and a transport plan #4 in which the destination is set to a discard point P3 and no through point is set.

When the transport plan creation process in step S26 is completed, the server 50 determines whether the transport plan for the object 10 created by the transport plan creation process in step S26 has been changed from the transport plan for the object 10 created by the immediately preceding transport plan creation process (step S27).

When the transport plan for the object 10 created by the transport plan creation process in step S26 has been changed from the transport plan for the object 10 created by the immediately preceding transport plan creation process (step S27: YES), information indicating that the transport plan for the object 10 has been changed is transmitted to the first notification unit 71, the second notification unit 72, and the third notification unit 73 (step S28). In step S28, the server 50 may transmit, to the first notification unit 71, the second notification unit 72, and the third notification unit 73, the changed transport plan for the object 10, which is created by the transport plan creation process in step S26, or may transmit, to the first notification unit 71, the second notification unit 72, and the third notification unit 73, information indicating that the transport plan for the object 10 is changed to a plan for transporting the object 10 to the second point P2, that the transport plan is changed to a plan for aborting transporting of the object 10 to the second point P2, or that the transport plan is changed to a plan for discarding the object 10.

Further, the server 50 returns to step S19, and creates the movement plan for the first moving body 20 based on the newly created transport plan for the object 10, the various information stored in the environment information database 52, the various information such as position information and a moving state transmitted from the first moving body 20, an energy storage state of the mounted energy storage device, the presence or absence of the loading of the object 10, and a loading time of the object 10 loaded in the past, and various information such as position information and a moving state of the second moving body 30 transmitted from the second moving body 30, and the accommodation situation of the first moving body 20.

On the other hand, when the first moving body 20 arrives at the destination (step S22: YES), the first moving body 20 transmits, to the server 50, information indicating that the object 10 has arrived at the destination (step S29), and the process proceeds to step S32.

When the server 50 receives the information indicating that the first moving body 20 has arrived at the destination, the server 50 transmits the information to the second notification unit 72 and the third notification unit 73 (step S30). When the second notification unit 72 receives the information indicating that the first moving body 20 has arrived at the destination, the second notification unit 72 notifies the receiver B of the information indicating that the first moving body 20 has arrived at the destination, and when the third notification unit 73 receives the information indicating that the first moving body 20 has arrived at the destination, the third notification unit 73 notifies the system administrator C of the information indicating that the first moving body 20 has arrived at the destination. Accordingly, the receiver B and the system administrator C can recognize that the first moving body 20 has arrived at the destination. The information may be transmitted from the first moving body 20 to the second notification unit 72 and the third notification unit 73 via the communication network 80 without passing through the server 50.

In a case in which a latest created transport plan for the object 10 is the transport plan #3 in which the destination is set to the disinfection station 40 or the transport plan #4 in which the destination is set to the discard point P3, in step S30, transmitting the information indicating that the first moving body 20 has arrived at the destination to the second notification unit 72 may be omitted.

When the transport plan for the object 10 created by the transport plan creation process in step S26 is not changed from the transport plan for the object 10 created by the immediately preceding transport plan creation process (step S27: NO), the server 50 proceeds to step S31, and determines whether the information indicating that the first moving body 20 has arrived at the destination is received from the first moving body 20.

When the information indicating that the first moving body 20 has arrived at the destination has not been received from the first moving body 20 (step S31: NO), the process returns to step S25, and when the information regarding the state of the object 10 loaded in the first moving body 20 in step S24 transmitted from the first moving body 20 is received, the process proceeds to the harmful degree determination process of the object 10 in step S25.

In step S32, the loaded object 10 is unloaded from the first moving body 20 at the destination.

In the present embodiment, when the created latest transport plan for the object 10 is the transport plan #1 or the transport plan #2 in which the destination is set to the second point P2, the object 10 arrives at the second point P2 which is the destination, and the object 10 is unloaded at the second point P2. At this time, since the receiver B can recognize that the first moving body 20 has arrived at the destination in step S30, the receiver B may unload the object 10 from the first moving body 20 at the second point P2. Further, the first moving body 20 may include an unloading device that unloads the object 10, and the unloading device of the first moving body 20 may be operated at the second point P2 to unload the object 10 from the first moving body 20. Further, the unloading device that unloads the object 10 may be provided at the second point P2, and the unloading device may be operated at the second point P2 to unload the object 10 from the first moving body 20.

In the present embodiment, when the transport plan for the created latest object 10 is the transport plan #3 in which the destination is set to the disinfection station 40, the object 10 arrives at the disinfection station 40 which is the destination, and after the first moving body 20 and the object 10 loaded in the first moving body 20 are disinfected in the disinfection chamber 41, the object 10 is unloaded at the disinfection station 40. At this time, the first moving body 20 may include the unloading device that unloads the object 10, and the unloading device of the first moving body 20 may operate at the disinfection station 40 to unload the object 10 from the first moving body 20. Further, the unloading device that unloads the object 10 may be provided at the disinfection station 40, and the unloading device may be operated at the disinfection station 40 to unload the object 10 from the first moving body 20.

Further, in the present embodiment, when the created latest transport plan for the object 10 is the transport plan #4 in which the destination is the discard point P3, the object 10 arrives at the discard point P3 which is the destination, and the object 10 is unloaded at the discard point P3. At this time, the first moving body 20 may include the unloading device that unloads the object 10, and the unloading device of the first moving body 20 may be operated at the discard point P3 to unload the object 10 from the first moving body 20. Further, the unloading device that unloads the object 10 may be provided at the discard point P3, and the unloading device may be operated at the discard point P3 to unload the object 10 from the first moving body 20.

When step S32 is completed and the loaded object 10 is unloaded at the destination, the first moving body 20 transmits, to the server 50, information indicating that transporting of the object 10 has been completed (step S33).

When the information indicating that transporting of the object 10 has been completed is received, the server 50 transmits the information to the first notification unit 71, the second notification unit 72, and the third notification unit 73 (step S34). When the first notification unit 71 receives the information indicating that transporting of the object 10 has been completed, the first notification unit 71 notifies the sender A of the information indicating that transporting of the object 10 has been completed, when the second notification unit 72 receives the information indicating that transporting of the object 10 has been completed, the second notification unit 72 notifies the receiver B of the information indicating that transporting of the object 10 has been completed, and when the third notification unit 73 receives the information indicating that transporting of the object 10 has been completed, the third notification unit 73 notifies the system administrator C of the information indicating that transporting of the object 10 has been completed. Accordingly, the sender A, the receiver B, and the system administrator C can recognize that transporting of the object 10 has been completed. The information may be transmitted from the first moving body 20 to the first notification unit 71, the second notification unit 72, and the third notification unit 73 via the communication network 80 without passing through the server 50.

In a case in which the information indicating that the first moving body 20 has arrived at the destination is received from the first moving body 20 (step S31: YES), the server 50 proceeds to step S35 when the information indicating that transporting of the object 10 has been completed, which is transmitted from the first moving body 20, is received in step S33.

In step S35, the server 50 executes the harmful degree determination process of the first moving body 20 in the harmful degree determination unit 53, and determines a harmful degree Hm of the first moving body 20 in which the object 10 is loaded. For example, in the harmful degree determination process of the first moving body 20, the harmful degree Hm of the first moving body 20 in which the object 10 is loaded is determined based on the harmful degree H of the object 10 acquired by the harmful degree determination process of the object 10 executed in step S15 and step S25 described above, the loading time of the object 10 in the first moving body 20, the movement history of the first moving body 20, the map information stored in the environment information database 52, the infectious disease epidemic information, and the like.

For example, the harmful degree Hm of the first moving body 20 is determined by the same process as the harmful degree determination process of the object 10 executed in step S15 and step S25 described above.

Further, when the harmful degree determination process of the first moving body 20 in step S35 is completed, a series of processes of transporting the object 10 from the first point P1 to the destination is ended.

(Harmful Degree Determination Process of Conveyance Object)

Next, the harmful degree determination process of the object 10 in step S15 described above will be described. The harmful degree determination process of the object 10 is performed by the harmful degree determination unit 53 of the server 50. The following harmful degree determination process of the object 10 is an example, and the harmful degree of the object 10 may be acquired by executing any harmful degree determination process.

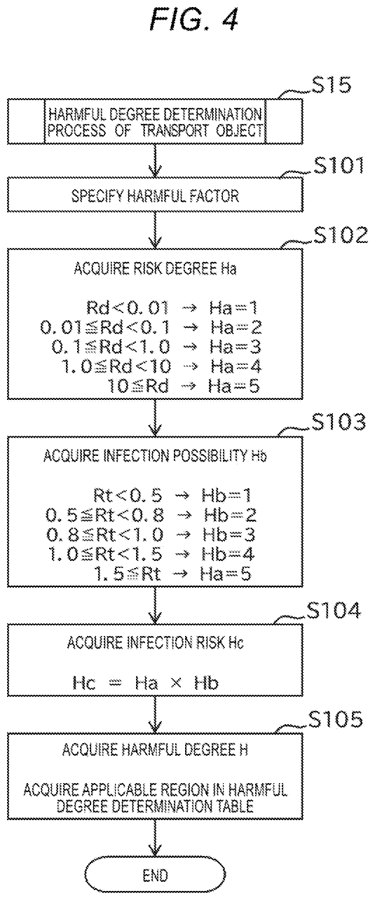

As shown in FIG. 4, in the harmful degree determination process of the object 10, the harmful degree determination unit 53 first specifies the harmful factor such as a virus or a bacterium that may adhere to the object 10 based on the information on the state of the sender A transmitted in step S13 and the information on the state of the object 10 loaded in the first moving body 20 which is transmitted in step S14 (step S101). The harmful factor specified in step S101 may be one or more. If there are a plurality of harmful factors specified in step S101, subsequent steps S102 to S105 may be performed for each of the specified harmful factors.

Next, a risk degree evaluation process is executed for the harmful factor specified in step S101, and a risk degree Ha is acquired (step S102). In the present embodiment, by the risk degree evaluation process, the risk degree Ha is acquired as five levels of numerical values of 1, 2, 3, 4, and 5, in an increasing order of the risk degree.

In the risk degree evaluation process, for example, a mortality rate R_{d} of the harmful factor specified in step S101, which is acquired from the infectious disease information stored in the environment information database 52, is divided into five regions, and the risk degree Ha is acquired as the five levels of numerical values of 1, 2, 3, 4, and 5 in order from a region having a lowest mortality rate R_{d}.

For example, the risk degree Ha is set to 1 when the mortality rate R_{d} is R_{d}<0.01, the risk degree Ha is set to 2 when the mortality rate R_{d} is 0.01≤R_{d}<0.1, the risk degree Ha is set to 3 when the mortality rate R_{d} is 0.1≤R_{d}<1.0, the risk degree Ha is set to 4 when the mortality rate R_{d} is 1.0≤R_{d}<10, and the risk degree Ha is set to 5 when the mortality rate R_{d} is 10≤R_{d}.

Next, an infection possibility Hb is acquired by executing an infection possibility evaluation process for the harmful factor specified in step S101 (step S103). In the present embodiment, by the infection possibility evaluation process, the infection possibility Hb is acquired as five levels of numerical values of 1, 2, 3, 4, and 5 in an increasing order of the infection possibility.

In the infection possibility evaluation process, for example, an effective reproduction number Rₜ of the harmful factor specified in step S101, which is acquired from the infectious disease information stored in the environment information database 52, is divided into five regions, and the infection possibility Hb is acquired as the five levels of numerical values of 1, 2, 3, 4, and 5 in order from a region having a lowest effective reproduction number Rₜ.

For example, the infection possibility Hb is set to 1 when the effective reproduction number Rₜ is Rₜ<0.5, the infection possibility Hb is set to 2 when the effective reproduction number Rₜ is 0.5≤Rₜ<0.8, the infection possibility Hb is set to 3 when the effective reproduction number Rₜ is 0.8≤Rₜ<1.0, the infection possibility Hb is set to 4 when the effective reproduction number Rₜ is 1.0≤Rₜ<1.5, and the infection possibility Hb is set to 5 when the effective reproduction number Rₜ is 1.5≤Rₜ.

Next, an infection risk Hc is acquired based on the risk degree Ha acquired in step S102 and the infection possibility Hb acquired in step S103 (step S104). In the present embodiment, the infection risk Hc is a numerical value expressed by a product of the risk degree Ha acquired in step S102 and the infection possibility Hb acquired in step S103.

Next, the harmful degree H of the object 10 is acquired based on the risk degree Ha acquired in step S102, the infection possibility Hb acquired in step S103, and the infection risk Hc acquired in step S104 (step S105).

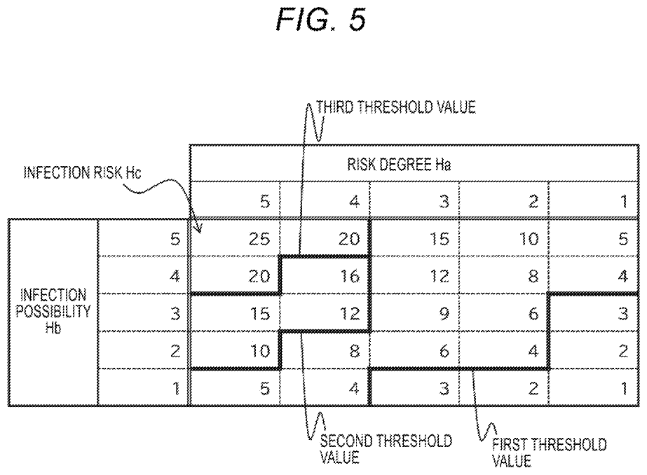

In the present embodiment, as illustrated in FIG. 5, the harmful degree determination unit 53 includes a harmful degree determination table including the risk degree Ha, the infection possibility Hb, and the infection risk Hc. Further, the harmful degree H of the object 10 is indicated by a region of the harmful degree determination table in which the harmful degree H is located based on the risk degree Ha acquired in step S102, the infection possibility Hb acquired in step S103, and the infection risk He acquired in step S104. When step S105 is completed, the harmful degree determination process of the object 10 is completed.

(Conveyance Plan Creation Process)

Next, the transport plan creation process of the object 10 in step S17 described above will be described. The transport plan creation process of the object 10 is executed by the transport plan creation unit 54 of the server 50. The transport plan creation process of the object 10 to be described below is an example, and any transport plan creation process may be executed to create the transport plan for the object 10.

In the transport plan creation process, the transport plan creation unit 54 creates the transport plan for the object 10 in which the destination and the through point are set, based on the harmful degree H of the object 10 acquired in the above-described harmful degree determination process.

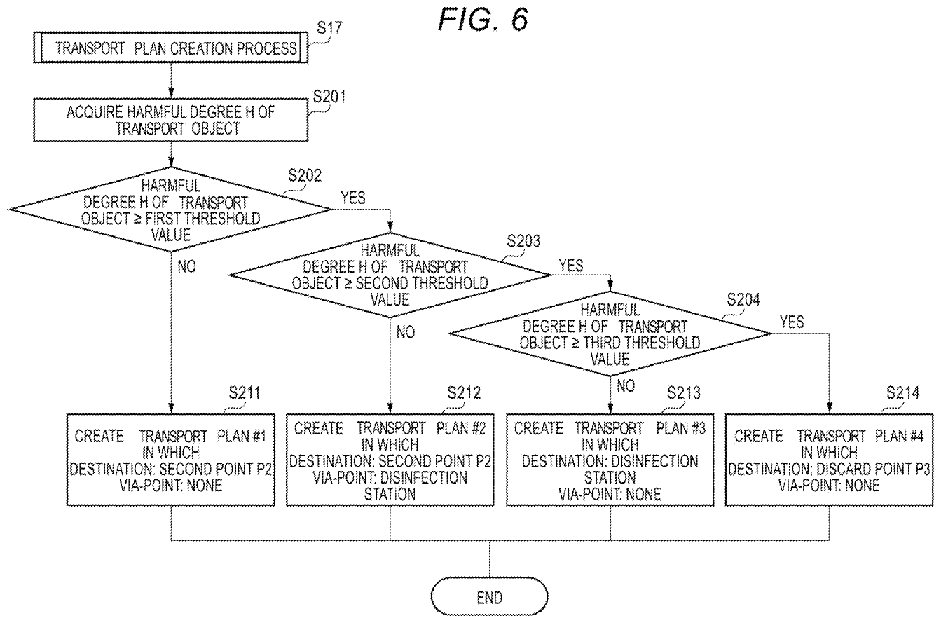

As illustrated in FIG. 6, the transport plan creation unit 54 first acquires, from the harmful degree determination unit 53, the harmful degree H of the object 10 acquired in the above-described harmful degree determination process (step S201).

Subsequently, the transport plan creation unit 54 determines whether the acquired harmful degree H of the object 10 is equal to or greater than the first threshold value (step S202). In the present embodiment, the first threshold value is the infection risk Hc=4 (see FIG. 5).

When the acquired harmful degree H of the object 10 is less than the first threshold value, that is, when the acquired infection risk He of the harmful degree H of the object 10 is less than 4 (step S202: NO), the transport plan creation unit 54 creates the transport plan #1 in which the destination is set to the second point P2 and no through point is set (step S211), and ends the transport plan creation process. The transport plan #1 is a transport plan for transporting the object 10 to the second point P2 without passing through the disinfection station 40.

Accordingly, when the obtained harmful degree H of the object 10 is low, the object 10 can be transported efficiently to the second point P2.

When the acquired harmful degree H of the object 10 is equal to or greater than the first threshold value, that is, when the acquired infection risk He of the harmful degree H of the object 10 is equal to or greater than 4 (step S202: YES), the transport plan creation unit 54 determines whether the acquired harmful degree H of the object 10 is equal to or greater than the second threshold value (step S203). In the present embodiment, the second threshold value is the risk degree Ha=4 and the infection risk Hc=10 (see FIG. 5).

When the acquired harmful degree H of the object 10 is less than the second threshold value, that is, when the risk degree Ha is less than 4 or the infection risk He is less than 10 with respect to the acquired harmful degree H of the object 10 (step S203: NO), the transport plan creation unit 54 creates the transport plan #2 in which the destination is set to the second point P2 and the through point is set to the disinfection station 40 (step S212), and ends the transport plan creation process. The transport plan #2 is a transport plan for transporting the object 10 to the second point P2 after the object 10 passes through the disinfection station 40, is disinfected in the disinfection chamber 41 to reduce the harmful degree of the object 10.

Accordingly, when the acquired harmful degree H of the object 10 is equal to or greater than the first threshold value, after the harmful degree of the object 10 is reduced, the object 10 can be transported to the second point P2, and thus it is possible to prevent the harmful factor such as a virus and a bacterium from spreading through the medium of the object 10.

When the acquired harmful degree H of the object 10 is equal to or greater than the second threshold value, that is, when the risk degree Ha is equal to or greater than 4 and the infection risk He is equal to or greater than 10 with respect to the acquired harmful degree H of the object 10 (step S203. YES), the transport plan creation unit 54 determines whether the acquired harmful degree H of the object 10 is equal to or greater than the third threshold value (step S204). In the present embodiment, the third threshold value is the infection risk Hc=20 (see FIG. 5).

When the acquired harmful degree H of the object 10 is less than the third threshold value, that is, when the acquired infection risk Hc of the harmful degree H of the object 10 is less than 20 (step S204: NO), the transport plan creation unit 54 creates the transport plan #3 in which the destination is set to the disinfection station 40 and no through point is set (step S213), and ends the transport plan creation process. The transport plan #3 is a transport plan in which the destination is set to the disinfection station 40, the object 10 is unloaded at the disinfection station 40 after the object 10 is disinfected in the disinfection chamber 41 to reduce the harmful degree of the object 10, and transporting of the object 10 to the second point P2 is aborted.

Accordingly, when the acquired harmful degree H of the object 10 is equal to or greater than the second threshold value, transporting of the object 10 to the second point P2 can be aborted, and thus it is possible to more reliably prevent the harmful factor such as a virus and a bacterium from spreading through the medium of the object 10 due to transporting of the object 10 to the second point P2, when the harmful degree of the object 10 is high.

When the acquired harmful degree H of the object 10 is equal to or greater than the third threshold value, that is, when the acquired infection risk Hc of the harmful degree H of the object 10 is equal to or greater than 20 (step S204: YES), the transport plan creation unit 54 creates the transport plan #4 in which the destination is set to the discard point P3 and no through point is set (step S214), and ends the transport plan creation process. The transport plan #4 is a transport plan in which the destination is set to the discard point P3, and the object 10 is discarded at the discard point P3 without transporting the object 10 to the second point P2.

Accordingly, when the acquired harmful degree H of the object 10 is equal to or greater than the third threshold value, the object 10 is discarded without being transported to the second point P2, and thus it is possible to more reliably prevent the harmful factor such as a virus and a bacterium from spreading through the medium of the object 10 due to transporting of the object 10 to the second point P2 when the harmful degree of the object 10 is high.

As described above, the first threshold value, the second threshold value, and the third threshold value may be threshold values of a single parameter or a combination of a plurality of threshold values of different parameters. By setting the first threshold value, the second threshold value, and the third threshold value to the threshold values of the single parameter, control can be simplified. On the other hand, by setting the first threshold value, the second threshold value, and the third threshold value to the combination of the plurality of threshold values of the different parameters, the first threshold value, the second threshold value, and the third threshold value can be set more finely, and the transport plan can be created more finely according to the harmful degree H of the object 10.

### Second Embodiment

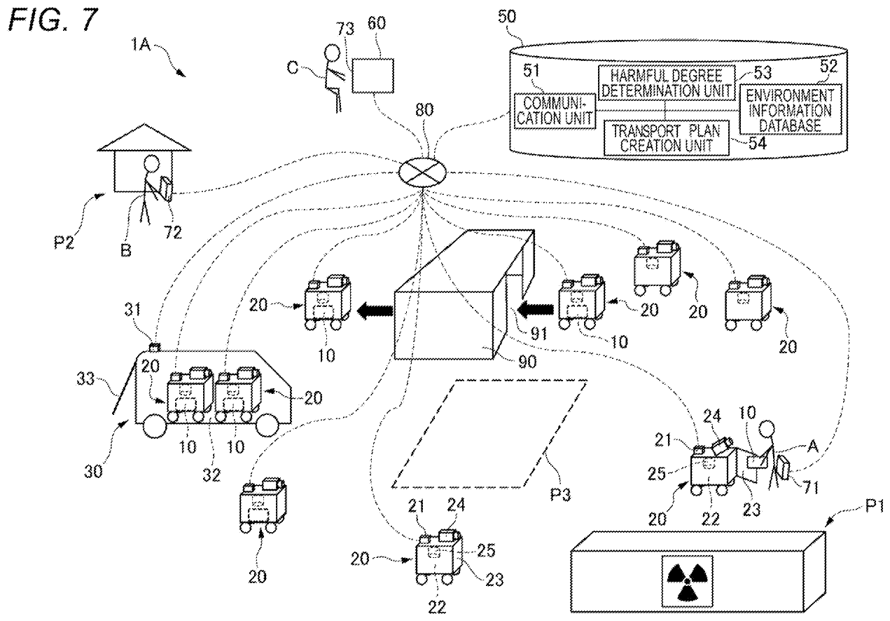

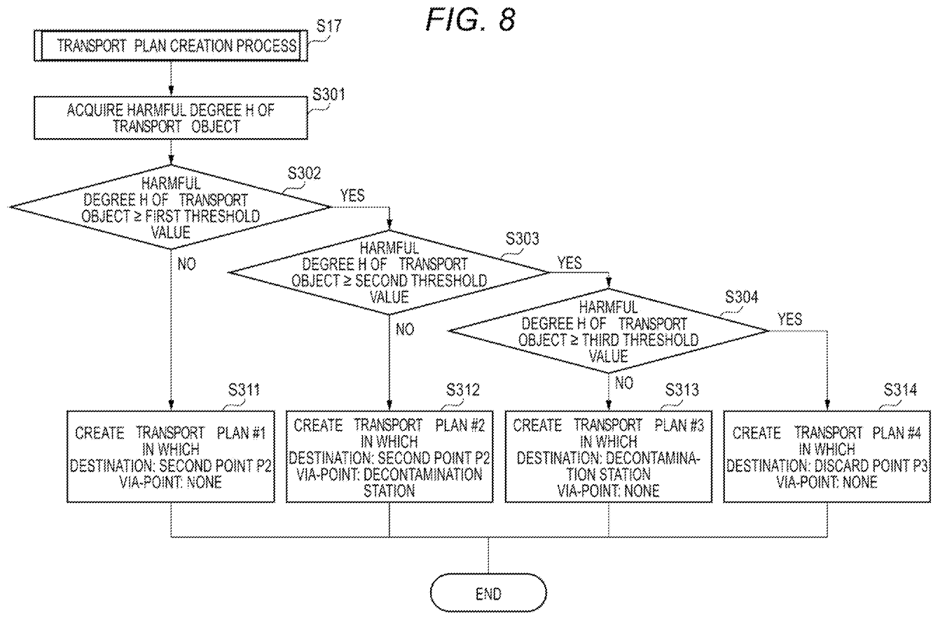

Next, a system 1A for transporting an object according to a second embodiment of the present invention will be described with reference to FIGS. 7 and 8. In the following description, the same components as those of the system 1 according to the first embodiment are denoted by the same reference numerals, and the description thereof is omitted or simplified.

As shown in FIG. 7, the system 1 according to the first embodiment includes the disinfection station 40, but the system 1A according to the second embodiment includes a decontamination station 90 instead of the disinfection station 40. That is, the system 1A includes the objects 10, the first moving bodies 20, the second moving body 30, the decontamination station 90, the server 50, the system management terminal 60, the first notification unit 71, the second notification unit 72, and the third notification unit 73. Hereinafter, differences between the system 1 according to the first embodiment and the system 1A according to the second embodiment will be described in detail.

Information on a state of the sender A acquired by the sender state acquisition unit 24 mounted on the first moving body 20 is, for example, the dose of radiation emitted from the sender A, an outside exposure dose of the sender A, an inside exposure dose of the sender A, a movement history, an action history, contact information, and the like of the sender A. The sender state acquisition unit 24 is, for example, a dosimeter, a film badge, a whole body counter, or the like. Further, the sender state acquisition unit 24 may be an information terminal that can be input by the sender A, which includes a display device, and may acquire information on the state of the sender A based on information input by the sender A with respect to a question item displayed on the display device.

The information on the state of the object 10 acquired by the transport object state acquisition unit 25 mounted on the first moving body 20 is, for example, the dose of radiation emitted from the object 10, the movement history of the object 10, the contact information, or the like. The transport object state acquisition unit 25 is, for example, a dosimeter.

The decontamination station 90 includes a decontamination chamber 91 capable of accommodating the object 10 loaded in the first moving body 20 and the first moving body 20. In the decontamination station 90, the first moving body 20 accommodated in the decontamination chamber 91 and the object 10 loaded in the first moving body 20 can be decontaminated. For example, in the decontamination station 90, when the first moving body 20 is accommodated in the decontamination chamber 91, the swing door 23 is opened to be in the open state. Thus, a decontamination reagent is sprayed into an interior of the decontamination chamber 91, and the first moving body 20 accommodated in the decontamination chamber 91 and the object 10 loaded in the first moving body 20 are decontaminated. In the decontamination station 90, water containing a surface active agent or the like is jetted toward the first moving body 20 accommodated in the decontamination chamber 91 and the object 10 loaded in the first moving body 20, so that radioactive substances adhering to the first moving body 20 accommodated in the decontamination chamber 91 and the object 10 loaded in the first moving body 20 may be removed.

The environment information database 52 may further store a radiation dose measurement map indicating radiation monitoring information of each place. The radiation dose measurement map can be acquired from Nuclear Regulatory Commission, a private company that provides a radiation dose measurement map, an information terminal mounted on a moving body such as a vehicle, a personal digital assistant, or the like.

In the present embodiment, the harmful degree determination unit 53 determines a risk of radiation exposure from the object 10 loaded in the first moving body 20 as a harmful degree to the living organism of the object 10 loaded in the first moving body 20.

Furthermore, in the present embodiment, the harmful degree determination unit 53 determines the risk of radiation exposure from the first moving body 20 as the harmful degree H of the first moving body 20 to the living organism, based on the harmful degree to the living organism of the object 10 loaded in the first moving body 20, the loading time of the object 10 loaded in the first moving body 20, the movement history of the first moving body 20, and various information stored in the environment information database 52.

(Harmful Degree Determination Process of Conveyance Object)

Next, the harmful degree determination process of the object 10 in the present embodiment will be described.

In the harmful degree determination process of the object 10, the harmful degree determination unit 53 acquires the harmful degree H to the living organism of the object 10 loaded in the first moving body 20 based on the information on the state of the sender A transmitted in step S13 and the information on the state of the object 10 loaded in the first moving body 20 transmitted in step S14.

In the present embodiment, a dose equivalent [μSv/h] (microsievert per hour) of the radiation emitted from the object 10 is acquired as the harmful degree H of the first moving body 20 to the living organism.

(Conveyance Plan Creation Process)

Next, the transport plan creation process of the object 10 in the present embodiment will be described.

As shown in FIG. 8, the flowchart of the transport plan creation process is the same as the transport plan creation process according to the first embodiment, except that the disinfection station 40 in the transport plan creation process according to the first embodiment shown in FIG. 6 is the decontamination station 90. The harmful degree H of the object 10 acquired from the harmful degree determination unit 53, the first threshold value, the second threshold value, and the third threshold value are different from those of the first embodiment.

The transport plan creation unit 54 first acquires the harmful degree H of the object 10 acquired in the above-described harmful degree determination process from the harmful degree determination unit 53 (step S301). In the present embodiment, the harmful degree H of the object 10 acquired by the transport plan creation unit 54 from the harmful degree determination unit 53 is the dose equivalent [μSv/h] (microsievert per hour) of the radiation emitted from the object 10.

Subsequently, the transport plan creation unit 54 determines whether the acquired harmful degree H of the object 10 is equal to or greater than the first threshold value (step S302). In the present embodiment, the first threshold value is, for example, 0.23 [μSv/h](microsieverts per hour) for the harmful degree H.

When the acquired harmful degree H of the object 10 is less than the first threshold value, that is, when the acquired harmful degree H of the object 10 is less than 0.23 [μSv/h](microsieverts per hour) (step S302: NO), the transport plan creation unit 54 creates a transport plan #1 in which the destination is set to the second point P2 and no through point is set (step S311), and ends the transport plan creation process. The transport plan #1 is a transport plan for transporting the object 10 to the second point P2 without passing through the decontamination station 90.

Accordingly, when the obtained harmful degree H of the object 10 is low, the object 10 can be transported efficiently to the second point P2.

When the acquired harmful degree H of the object 10 is equal to or greater than the first threshold value, that is, when the acquired harmful degree H of the object 10 is equal to or greater than 0.23 [μSv/h] (microsieverts per hour) (step S302: YES), the transport plan creation unit 54 determines whether the acquired harmful degree H of the object 10 is equal to or greater than the second threshold value (step S303). In the present embodiment, the second threshold value is, for example, 3.84 [μSv/h] (microsieverts per hour) for the harmful degree H.

When the acquired harmful degree H of the object 10 is less than the second threshold value, that is, when the acquired harmful degree H of the object 10 is less than 3.84 [μSv/h] (microsieverts per hour) (step S303: NO), the transport plan creation unit 54 creates a transport plan #2 in which the destination is set to the second point P2 and the through point is set to the decontamination station 90 (step S312), and ends the transport plan creation process. The transport plan #2 is a transport plan for transporting the object 10 to the second point P2 after the object 10 passes through the decontamination station 90, is disinfected in the decontamination chamber 91 to reduce the harmful degree of the object 10.

Accordingly, when the acquired harmful degree H of the object 10 is equal to or greater than the first threshold value, after the harmful degree of the object 10 is reduced, the object 10 can be transported to the second point P2, and thus it is possible to prevent the radioactive substances from diffusing through the medium of the object 10.

When the acquired harmful degree H of the object 10 is equal to or greater than the second threshold value, that is, when the acquired harmful degree H of the object 10 is equal to or greater than 3.84 [μSv/h] (microsieverts per hour) (step S303: YES), the transport plan creation unit 54 determines whether the acquired harmful degree H of the object 10 is equal to or greater than the third threshold value (step S304). In the present embodiment, the third threshold value is, for example, 19.06 [μSv/h] (microsieverts per hour) for the harmful degree H.

When the acquired harmful degree H of the object 10 is less than the third threshold value, that is, when the acquired harmful degree H of the object 10 is less than 19.06 [μSv/h](microsieverts per hour) (step S304: NO), the transport plan creation unit 54 creates a transport plan #3 in which the destination is set to the decontamination station 90 and no through point is set (step S313), and ends the transport plan creation process. The transport plan #3 is a transport plan in which the destination is set to the decontamination station 90, the object 10 is unloaded at the decontamination station 90 after the object 10 is disinfected in the decontamination chamber 91 to reduce the harmful degree of the object 10, and transporting of the object 10 to the second point P2 is aborted.

Accordingly, when the acquired harmful degree H of the object 10 is equal to or greater than the second threshold value, transporting of the object 10 to the second point P2 can be aborted, and thus it is possible to more reliably prevent the radioactive substances from diffusing through the medium of the object 10 due to transporting of the object 10 to the second point P2, when the harmful degree of the object 10 is high.

When the acquired harmful degree H of the object 10 is equal to or greater than the third threshold value, that is, when the acquired harmful degree H of the object 10 is equal to or greater than 19.06 [μSv/h] (microsieverts per hour) (step S304: YES), the transport plan creation unit 54 creates a transport plan #4 in which the destination is set to the discard point P3 and no through point is set (step S314), and ends the transport plan creation process. The transport plan #4 is a transport plan in which the destination is set to the discard point P3, and the object 10 is discarded at the discard point P3 without transporting the object 10 to the second point P2.

Accordingly, when the acquired harmful degree H of the object 10 is equal to or greater than the third threshold value, the object 10 is discarded without being transported to the second point P2, and thus it is possible to more reliably prevent the radioactive substances from diffusing through the medium of the object 10 due to the transporting of the object 10 to the second point P2 when the harmful degree of the object 10 is high.

### Third Embodiment

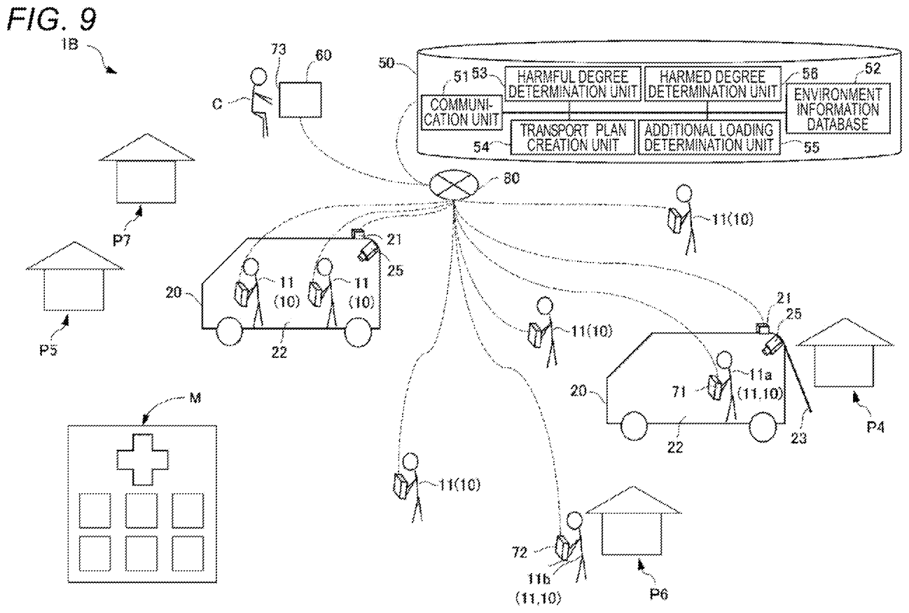

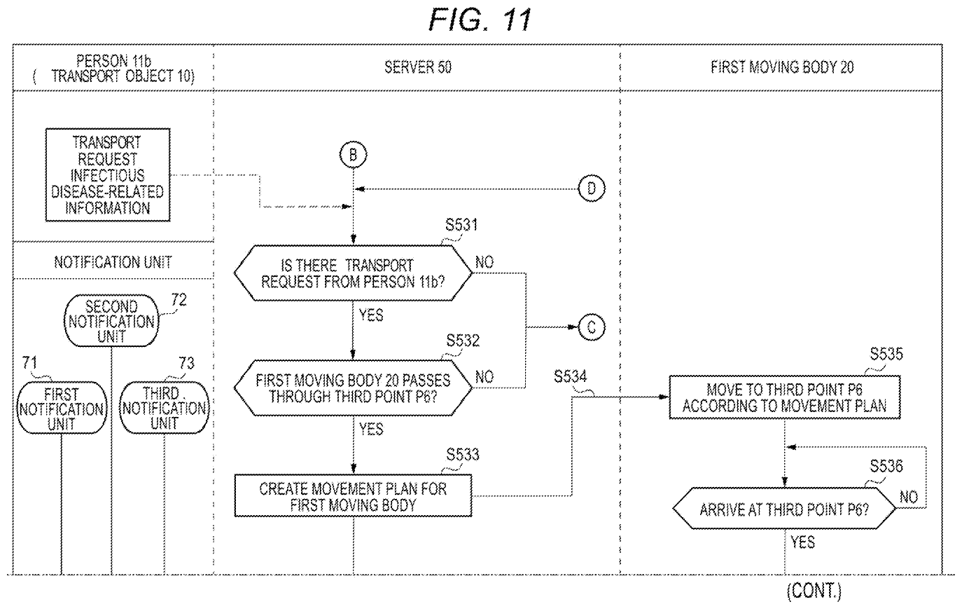

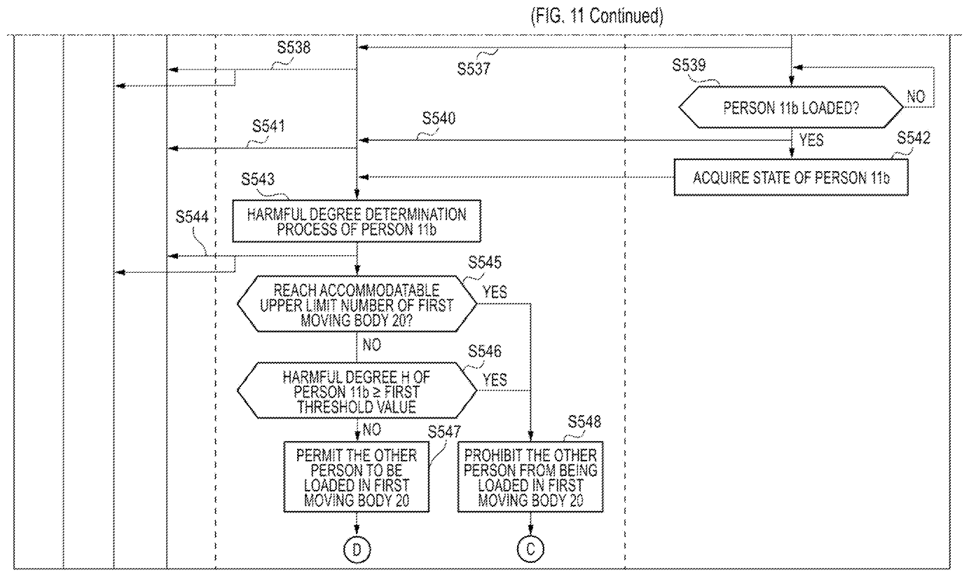

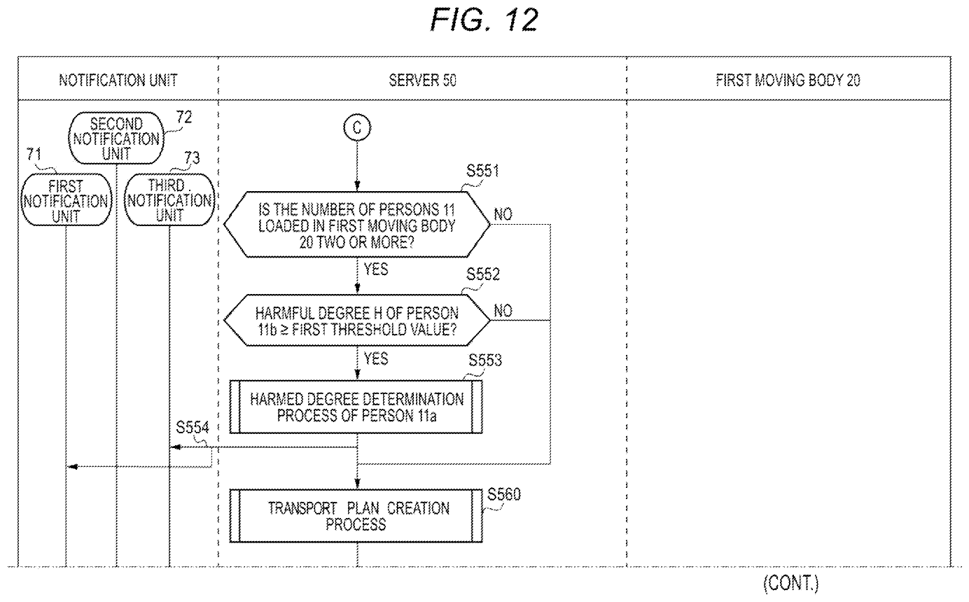

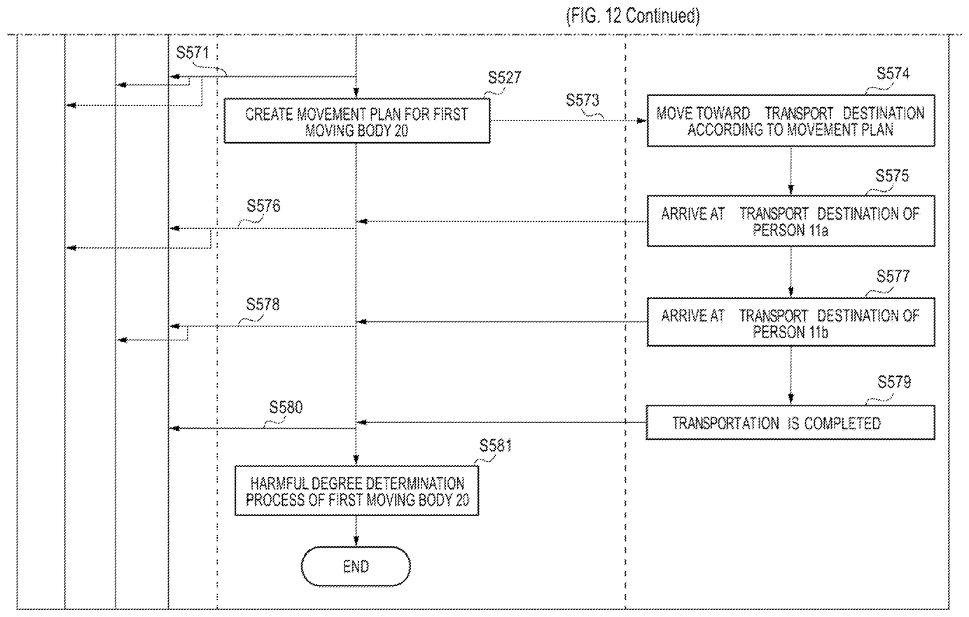

Next, a system 1B for transporting an object according to a third embodiment of the present invention will be described with reference to FIGS. 9 to 14. In the following description, the same components as those of the system 1 according to the first embodiment are denoted by the same reference numerals, and the description thereof is omitted or simplified.

As shown in FIG. 9, in the system 1B according to the third embodiment, the object 10 is a person 11. In the system 1B according to the third embodiment, the first moving body 20 is capable of loading a plurality of persons 11, which are the objects 10. The system 1B according to the third embodiment includes a medical institution M in place of the disinfection station 40 and the discard point P3 in the system 1 according to the first embodiment. In the system 1B according to the third embodiment, the second moving body 30 in the system 1 according to the first embodiment is omitted.

Therefore, the system 1B according to the third embodiment includes the persons 11 which are the objects 10, the first moving bodies 20 capable of loading the plurality of persons 11 which are the objects 10, the medical institution M, the server 50, and the system management terminal 60. The system 1B may include the plurality of first moving bodies 20, and each of the plurality of first moving bodies 20 may transport the plurality of persons 11.

The first moving body 20 includes the accommodating portion 22 capable of accommodating the plurality of persons 11 therein. The first moving body 20 further includes an openable and closable swing door 23, and when the swing door 23 is in an open state, the object 10 can enter the accommodating portion 22 from an outside of the first moving body 20. Therefore, when the swing door 23 of the first moving body 20 is in the open state, the person 11 gets in the accommodating portion 22 from an outside of the first moving body 20, is loaded in the first moving body 20, and is accommodated in the accommodating portion 22 of the first moving body 20.

The first moving body 20 is equipped with a transport object state acquisition unit 25. For example, the transport object state acquisition unit 25 is disposed inside the accommodating portion 22. The transport object state acquisition unit 25 acquires the number of persons 11 loaded in the accommodating portion 22 of the first moving body 20 and information on a state of the person 11 loaded in the accommodating portion 22 of the first moving body 20. The information on the state of the person 11 is, for example, the presence or absence of adhering of a virus, a bacterium, or the like, the presence or absence of mask attachment of the person 11, a vaccination history, a movement history, contact information, and the like. The transport object state acquisition unit 25 may include, for example, a sensor device including a light emitting element capable of emitting ultraviolet rays or infrared rays and an image pickup element, or may include a detection device that detects a gene sequence or a protein of a virus, a bacterium, or the like. Further, the transport object state acquisition unit 25 may include a temperature sensor, a humidity sensor, an atmospheric pressure sensor, and the like that can acquire a temperature, humidity, an atmospheric pressure, and the like inside the accommodating portion 22, respectively. The transport object state acquisition unit 25 may include a wind speed sensor, a wind direction sensor, and the like capable of monitoring an airflow inside the accommodating portion 22. The information on the state of the person 11 acquired by the transport object state acquisition unit 25 may be, for example, a health condition of the person 11, such as a body temperature, a blood pressure, a blood flow, blood oxygen, the presence or absence of a cough, the presence or absence of a complexion abnormality, the presence or absence of infection of a virus, a bacterium, or the like, a movement history, an action history, contact information, and the like of the person 11. The transport object state acquisition unit 25 may include a camera, a microphone, a speaker, a hemomanometer, or the like, or may include a detection device that detects a gene sequence or a protein of a virus, a bacterium, or the like. Further, when the plurality of persons 11 are loaded in the accommodating portion 22 of the first moving body 20, the transport object state acquisition unit 25 can acquire the information on a state between the plurality of persons 11, such as an approach distance between the persons 11 and a contact time, in addition to acquiring the information on the state of each person 11.

The number of persons 11 loaded in the accommodating portion 22 of the first moving body 20 acquired by the transport object state acquisition unit 25 and the information on the state of the person 11 can be transmitted to the server 50 via the communication network 80. The transport object state acquisition unit 25 includes a transmission unit (not shown), and the number of persons 11 loaded in the accommodating portion 22 of the first moving body 20 acquired by the transport object state acquisition unit 25 and the information on the state of the person 11 may be transmitted from the transmission unit to the server 50 via the communication network 80. Further, the number of persons 11 loaded in the accommodating portion 22 of the first moving body 20 acquired by the transport object state acquisition unit 25 and the information on the state of the person 11 may be transmitted from the communication unit 21 of the first moving body 20 to the server 50 via the communication network 80.

Accordingly, even during the movement of the first moving body 20, the number of persons 11 loaded in the accommodating portion 22 of the first moving body 20 and the information on the state of the person 11 can be acquired.

The medical institution M is a medical institution capable of accommodating and treating the person 11 loaded in the first moving body 20 when the person 11 loaded in the first moving body 20 is infected with an infectious disease.

The harmful degree determination unit 53 determines the harmful degree to another person of each of the persons 11 loaded in the first moving body 20. The harmful degree determination unit 53 determines the harmful degree to the other person 11 of the person 11 loaded in the first moving body 20 based on the information on the state of the person 11 loaded in the accommodating portion 22 of the first moving body 20 acquired by the transport object state acquisition unit 25 and various information stored in the environment information database 52. In the present embodiment, an infection risk of the infectious disease caused by the virus, the bacterium, and the like, to the other person 11 through a medium of the person 11 loaded in the first moving body 20 is determined as the harmful degree to the other person 11 of the person 11 loaded in the first moving body 20.

Accordingly, since it is possible to determine the harmful degree to the other person 11 of the person 11 loaded in the first moving body 20, when there is the harmful factor in the person 11 which is the object 10, it is possible to prevent the harmful factor from spreading through the medium of the person 11.

The harmful degree determination unit 53 determines the harmful degree of the first moving body 20 to the other person. In the present embodiment, the infection risk of the infectious disease caused by the virus, the bacterium, or the like to the person through a medium of the first moving body 20 is determined as the harmful degree of the first moving body 20 to the other person based on the harmful degree to the other person 11 of the person 11 loaded in the first moving body 20, a loading time of the person 11 loaded in the first moving body 20, the movement history of the first moving body 20, and the various information stored in the environment information database 52.

In the present embodiment, the server 50 further includes an additional loading determination unit 55 and a harmed degree determination unit 56.

The additional loading determination unit 55 determines whether the other person 11 can be further loaded in the first moving body 20 based on the number of persons 11 loaded in the accommodating portion 22 of the first moving body 20 and the harmful degree H of each person 11 loaded in the first moving body 20, which is determined by the harmful degree determination unit 53.

When another person 11 is loaded in the first moving body 20, the harmed degree determination unit 56 determines a harmed degree D of the person 11 loaded in the first moving body 20 harmed by the other person 11 loaded in the first moving body 20.

The harmed degree determination unit 56 determines the harmed degree D based on at least one of the harmful degree H of each person 11 loaded in the first moving body 20, which is determined by the harmful degree determination unit 53, an epidemic prevention state of each person 11 loaded in the first moving body 20, an epidemic prevention state of the first moving body 20, a loading time during which the persons 11 loaded in the first moving body 20 are all loaded in the first moving body 20, a loading distance that all the persons 11 loaded in the first moving body 20 travel while being in the first moving body 20 at the same time, and an approach distance in the first moving body 20 of the persons 11 loaded in the first moving body 20.

Accordingly, the harmed degree determination unit 56 can determine the harmed degree D of the person 11 loaded in the first moving body 20 harmed by the other person 11 loaded in the first moving body 20.

<Processing Operation of Conveyance Object Conveying System>

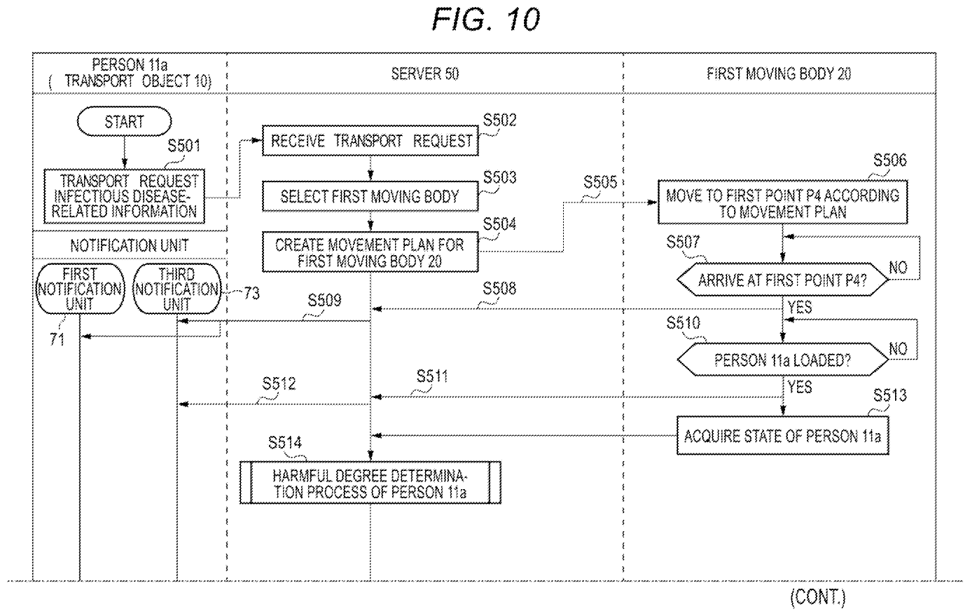

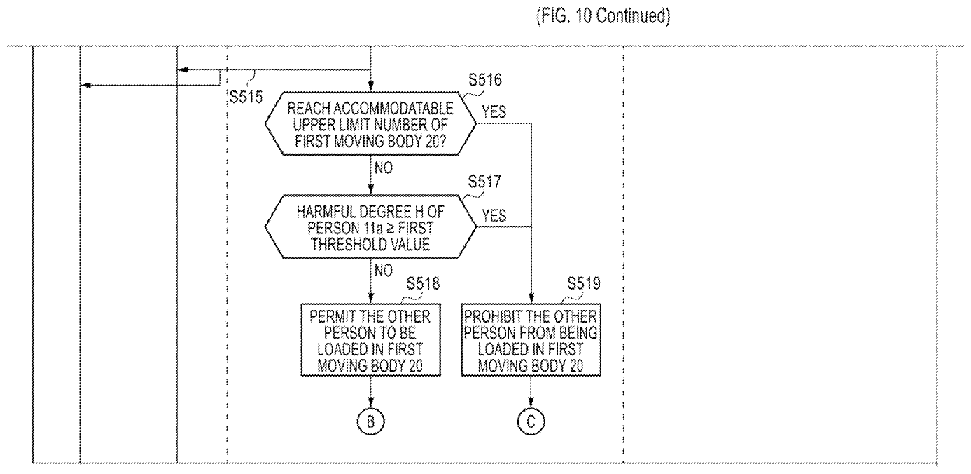

Next, the processing operation of the system 1 according to the present embodiment configured as described above will be specifically described with reference to FIGS. 10 to 14. In the present embodiment, as an example of a processing operation of the system 1B, a description will be given of a processing operation in a case in which an accommodatable upper limit of persons 11 in the first moving body 20 is two, a person 11a loaded in the first moving body 20 at a first point P4 is transported to a second point P5, and a person 11b loaded in the first moving body 20 at a third point P6 is transported to a fourth point P7.

As described above, the system 1 according to the present embodiment can load the person 11a in the first moving body 20 at the first point P4, and load the person 11b in the first moving body 20 at the third point P6. Therefore, the system 1 according to the present embodiment can transport the plurality of persons 11 (person 11a and person 11b) as the objects 10 from different points.

In the present embodiment, the first notification unit 71 notifies the person 11a of information. The first notification unit 71 is, for example, a display screen displayed on a display device of a personal digital assistant such as a smartphone owned by the person 11a. The first notification unit 71 notifies the person 11a of at least a part of a transport plan for the person 11a created by the transport plan creation unit 54. Further, when a harmful degree of the person 11a determined by the harmful degree determination unit 53 is equal to or greater than a predetermined threshold value, the first notification unit 71 notifies the person 11a of a determination result of the harmful degree determination unit 53 or information indicating that the harmful degree of the person 11a is equal to or greater than the predetermined threshold value. When the harmed degree D of the person 11a is equal to or greater than a predetermined threshold value, the first notification unit 71 notifies the person 11a of a determination result of the harmed degree D of the person 11a in a harmed degree determination process in the harmed degree determination unit 56 or the information indicating that the harmed degree D of the person 11a is equal to or greater than the predetermined threshold value.

The second notification unit 72 notifies the person 11b of the information. The second notification unit 72 is, for example, a display screen displayed on a display device of a personal digital assistant such as a smartphone owned by the person 11b. The second notification unit 72 notifies the person 11b of at least a part of a transport plan for the person 11b created by the transport plan creation unit 54. Further, when a harmful degree of the person 11b determined by the harmful degree determination unit 53 is equal to or greater than the predetermined threshold value, the second notification unit 72 notifies the person 11b of a determination result of the harmful degree determination unit 53 or information indicating that the harmful degree of the person 11b is equal to or greater than the predetermined threshold value. Although the description is omitted in the present embodiment, in a case in which the harmed degree determination unit 56 executes the harmed degree determination process for the person 11b, when the harmed degree D of the person 11b is equal to or greater than the predetermined threshold value, the second notification unit 72 may notify the person 11b of the determination result of the harmed degree D of the person 11b in the harmed degree determination process in the harmed degree determination unit 56 or the information indicating that the harmed degree D of the person 11b is equal to or greater than the predetermined threshold value.

The third notification unit 73 notifies the system administrator C of the information. The third notification unit 73 is, for example, a display screen displayed on a display device of the system management terminal 60. The third notification unit 73 notifies the system administrator C of at least a part of a transport plan created by the transport plan creation unit 54. Further, when the harmful degree of the person 11a and/or the person 11b determined by the harmful degree determination unit 53 is equal to or greater than the predetermined threshold value, the third notification unit 73 notifies the system administrator C of the determination result of the harmful degree determination unit 53 or the information indicating that the harmful degree of the person 11a and/or the person 11b is equal to or greater than the predetermined threshold value. When the harmed degree D of the person 11a is equal to or greater than the predetermined threshold value, the third notification unit 73 notifies the system administrator C of the determination result of the harmed degree D of the person 11a in the harmed degree determination process in the harmed degree determination unit 56 or the information indicating that the harmed degree D of the person 11a is equal to or greater than the predetermined threshold value Although the description is omitted in the present embodiment, in the case in which the harmed degree determination unit 56 executes the harmed degree determination process for the person 11b, when the harmed degree D of the person 11b is equal to or greater than the predetermined threshold value, the third notification unit 73 may notify the system administrator C of the determination result of the harmed degree D of the person 11b in the harmed degree determination process in the harmed degree determination unit 56 or the information indicating that the harmed degree D of the person 11b is equal to or greater than the predetermined threshold value.

First, when the person 11a makes a transport request to transport itself from the first point P4 to the second point P5 (step S501), the server 50 receives the transport request of the object 10 from the person 11a (step S502). The transport request is performed by, for example, operating the personal digital assistant owned by the person 11a by an application program stored in the personal digital assistant owned by the person 11a, thereby transmitting a transport request signal to the server 50 via the communication network 80. Further, the application program stored in the personal digital assistant can make the transport request on a condition that infectious disease-related information such as a vaccination certificate is transmitted to the server 50. Therefore, when the person 11a makes the transport request, the infectious disease-related information of the person 11a is transmitted to the server 50 via the communication network 80 together with the transport request signal. The server 50 receives the transport request signal and the infectious disease-related information of the person 11a via the communication network 80, thereby receiving the transport request of the object 10 from the person 11a.

When the server 50 receives the transport request from the person 11a, the server 50 selects the first moving body 20 to be moved to the first point P4 based on the infectious disease-related information of the person 11a received together with the transport request signal, the various information stored in the environment information database 52, various information such as position information and a moving state transmitted from each of the first moving bodies 20, an energy storage state of a mounted energy storage device, the presence or absence of the loading of the other person 11, and a loading time of the person 11 loaded in the past, the harmful degree of each of the first moving bodies 20 acquired in the harmful degree determination process of the first moving body 20 to be described later, and a determination result of the additional loading determination unit 55 of the first moving body 20 to be described later (step S503). Hereinafter, among the plurality of first moving bodies 20, the first moving body 20 selected in step S503 is referred to as the first moving body 20. Further, in the present embodiment, at this stage, a case in which the person 11 other than the person 11a is not riding (is not loaded) in the first moving body 20 is described as an example.

Subsequently, the server 50 creates a movement plan including movement of the first moving body 20 to the first point P4 based on the various information stored in the environment information database 52, and the various information such as position information and a moving state transmitted from the first moving body 20, an energy storage state of the mounted energy storage device, and the presence or absence of the loading of the other person 11 (step S504). Further, the server 50 transmits a movement instruction based on the created movement plan to the first moving body 20 (step S505).

The first moving body 20 that has received the movement instruction moves to the first point P4 according to the movement plan created by the server 50 (step S506).

The first moving body 20 determines whether the first moving body 20 has arrived at the first point P4 during the movement to the first point P4 (step S507), and when the first moving body 20 has not arrived at the first point P4 (step S507: a loop of NO), step S507 is repeated.

When the first moving body 20 arrives at the first point P4 (step S507: YES), the first moving body 20 transmits, to the server 50, information indicating that the first moving body 20 has arrived at the first point P4 (step S508), and the process proceeds to step S510.

When the server 50 receives the information indicating that the first moving body 20 has arrived at the first point P4, the server 50 transmits the information to the first notification unit 71 and the third notification unit 73 (step S509). When the first notification unit 71 receives the information indicating that the first moving body 20 has arrived at the first point P4, the first notification unit 71 notifies the person 11a that has made the transport request of the information indicating that the first moving body 20 has arrived at the first point P4. When the third notification unit 73 receives the information indicating that the first moving body 20 has arrived at the first point P4, the third notification unit 73 notifies the system administrator C of the information indicating that the first moving body 20 has arrived at the first point P4. Accordingly, the person 11a that has made the transport request and the system administrator C can recognize that the first moving body 20 has arrived at the first point P4. The information may be transmitted from the first moving body 20 to the first notification unit 71 and the third notification unit 73 via the communication network 80 without passing through the server 50.

Since the person 11a that has made the transport request can recognize that the first moving body 20 has arrived at the first point P4 by the first notification unit 71, it is possible to ride (load in) the first moving body 20 at the first point P4.

In step S510, the first moving body 20 determines whether the person 11a is loaded, and when the person 11a is not loaded (step S510: a loop of NO), the first moving body 20 repeats step S510.

When the person 11a is loaded (step S510: YES), the first moving body 20 transmits, to the server 50, information indicating that the person 11a is loaded (step S511), and the process proceeds to step S513.

When the server 50 receives the information indicating that the person 11a is loaded in the first moving body 20, the server 50 transmits the information to the third notification unit 73 (step S512). When the third notification unit 73 receives the information indicating that the person 11a is loaded in the first moving body 20, the third notification unit 73 notifies the system administrator C of the information indicating that the person 11a is loaded in the first moving body 20. Accordingly, the system administrator C can recognize that the person 11a is loaded in the first moving body 20. The information may be transmitted from the first moving body 20 to the third notification unit 73 via the communication network 80 without passing through the server 50.

In step S513, the first moving body 20 acquires, by the transport object state acquisition unit 25, the information on the state of the person 11a loaded in the first moving body 20, and transmits the information to the server 50.

When the server 50 receives the information on the state of the person 11a loaded in the first moving body 20, the server 50 proceeds to step S514, and in the harmful degree determination unit 53, executes the harmful degree determination process of the person 11a loaded at the first point P4, and acquires the harmful degree H of the person 11a to the other person 11. The harmful degree determination process of the person 11a in step S514 is the same as that in the case in which the object 10 in the first embodiment is replaced with the person 11a.

When the harmful degree determination process of the person 11a is completed in step S514, the server 50 transmits the information on the acquired harmful degree H of the person 11a to the first notification unit 71 and the third notification unit 73 (step S515).

The first notification unit 71 notifies the person 11a of a determination result of the harmful degree H of the person 11a in the harmful degree determination process performed by the harmful degree determination unit 53 based on the information on the harmful degree H of the person 11a received from the server 50 when the harmful degree H of the person 11a is equal to or greater than the predetermined threshold value, or information indicating that the harmful degree H of the person 11a is equal to or greater than the predetermined threshold value. For example, when the harmful degree H of the person 11a received from the server 50 is equal to or greater than the predetermined threshold value, the first notification unit 71 may display the determination result of the harmful degree H of the person 11a received from the server 50 on the display screen indicating the harmful degree of the person 11a.

The third notification unit 73 notifies the system administrator C of the determination result of the harmful degree of the person 11a in the harmful degree determination process performed by the harmful degree determination unit 53 based on the information on the harmful degree H of the person 11a received from the server 50 when the harmful degree H of the person 11a is equal to or greater than the predetermined threshold value, or the information indicating that the harmful degree H of the person 11a is equal to or greater than the predetermined threshold value. For example, when the harmful degree H of the person 11a received from the server 50 is equal to or greater than the predetermined threshold value, the third notification unit 73 display the determination result of the harmful degree of the person 11a received from the server 50 on the display screen indicating the harmful degree of the person 11a.

Accordingly, when the harmful degree H of the person 11a is equal to or greater than the predetermined threshold value, the person 11a and the system administrator C can recognize the determination result of the harmful degree of the person 11a in the harmful degree determination process in the harmful degree determination unit 53 or the information that the harmful degree H of the person 11a is equal to or greater than the predetermined threshold value.

Subsequently, the server 50 proceeds to step S516, and determines whether the number of persons 11 loaded in the accommodating portion 22 of the first moving body 20 has reached the accommodatable upper limit number of the accommodating portion 22 of the first moving body 20 based on the number of persons 11 loaded in the accommodating portion 22 of the first moving body 20 in the additional loading determination unit 55. When the number of persons 11 loaded in the accommodating portion 22 of the first moving body 20 reaches the accommodatable upper limit number of the accommodating portion 22 of the first moving body 20 (step S516: YES), the server 50 proceeds to step S519, prohibits loading the other person 11 in the first moving body 20, and proceeds to step S551. On the other hand, when the number of persons 11 loaded in the accommodating portion 22 of the first moving body 20 has not reached the accommodatable upper limit number of the accommodating portion 22 of the first moving body 20 (step S516: NO), the server 50 proceeds to step S517.

In step S517, the server 50 determines, in the additional loading determination unit 55, whether the harmful degree H of the person 11a loaded in the first moving body 20, which is determined by the harmful degree determination unit 53, is equal to or greater than the predetermined threshold value based on the harmful degree H of the person 11a loaded in the first moving body 20, which is determined by the harmful degree determination unit 53. The predetermined threshold value of the harmful degree H of the person 11a is, for example, the first threshold value in the harmful degree H according to the first embodiment, that is, the infection risk Hc=4 of the harmful degree H of the person 11a. When the harmful degree H of the person 11a determined by the harmful degree determination unit 53 is equal to or greater than the predetermined threshold value (step S517: YES), the server 50 proceeds to step S519, prohibits loading the other person 11 in the first moving body 20, and proceeds to step S551. On the other hand, in step S517, when the harmful degree H of the person 11a determined by the harmful degree determination unit 53 is less than the predetermined threshold value (step S517: NO), the server proceeds to step S518, permits the other person 11 to be loaded in the first moving body 20, and proceeds to step S531.

In this way, when the harmful degree H of the person 11a loaded in the first moving body 20 at the first point P4 is high, since the person 11b is prohibited from being loaded in the first moving body 20 at the third point P6, it is possible to prevent the harmful factor present in the person 11a loaded in the first moving body 20 at the first point P4 from spreading to the other person 11 in the first moving body 20.

Subsequently, in step S531, the server 50 determines whether there is a transport request from the other person 11b for transporting the other person 11b from the third point P6 to the fourth point P7. When there is the transport request from the other person 11b (step S531: YES), the server 50 proceeds to step S532, and when there is no transport request from the other person 11b (step S531: NO), the server 50 proceeds to step S551. In step S531, the application program stored in the personal digital assistant can make the transport request on the condition that the infectious disease-related information such as a vaccination certificate is transmitted to the server 50 as in step S501, and when the person 11b makes a transport request, infectious disease-related information of the person 11b is transmitted to the server 50 via the communication network 80 together with a transport request signal.

In step S532, the server 50 determines whether the first moving body 20 passes through the third point P6 based on the various information stored in the environment information database 52, and the various information such as position information and a moving state transmitted from the first moving body 20, an energy storage state of the mounted energy storage device, and the presence or absence of the loading of the other person 11, and the determination result of the additional loading determination unit 55. In step S532, when the server 50 determines that the first moving body 20 passes through the third point P6 (step S532: YES), the server 50 proceeds to step S533, and when the server 50 determines that the first moving body 20 does not pass through the third point P6, the server 50 proceeds to step S551.

In step S533, the server 50 creates a movement plan including movement of the first moving body 20 to the third point P6 based on the various information stored in the environment information database 52, and the various information such as position information and a moving state transmitted from the first moving body 20, an energy storage state of the mounted energy storage device, and the presence or absence of the loading of the other person 11. Further, the server 50 transmits a movement instruction based on the created movement plan to the first moving body 20 (step S534).

The first moving body 20 that has received the movement instruction moves to the third point P6 according to the movement plan created by the server 50 (step S535).

The first moving body 20 determines whether the first moving body 20 has arrived at the third point P6 during the movement to the third point P6 (step S536), and when the first moving body 20 has not arrived at the third point P6 (step S536: a loop of NO), step S536 is repeated.

When the first moving body 20 arrives at the third point P6 (step S536: YES), the first moving body 20 transmits, to the server 50, information indicating that the first moving body 20 has arrived at the third point P6 (step S537), and the process proceeds to step S539.

When the server 50 receives the information indicating that the first moving body 20 has arrived at the third point P6, the server 50 transmits the information to the second notification unit 72 and the third notification unit 73 (step S538). When the second notification unit 72 receives the information indicating that the first moving body 20 has arrived at the third point P6, the second notification unit 72 notifies the person 11b that has made the transport request of the information indicating that the first moving body 20 has arrived at the third point P6. When the third notification unit 73 receives the information indicating that the first moving body 20 has arrived at the third point P6, the third notification unit 73 notifies the system administrator C of the information indicating that the first moving body 20 has arrived at the third point P6. Accordingly, the person 11b that has made the transport request and the system administrator C can recognize that the first moving body 20 has arrived at the third point P6. The information may be transmitted from the first moving body 20 to the second notification unit 72 and the third notification unit 73 via the communication network 80 without passing through the server 50.

Since the person 11b that has made the transport request can recognize that the first moving body 20 has arrived at the third point P6 by the second notification unit 72, it is possible to ride (load in) the first moving body 20 at the third point P6.

In step S539, the first moving body 20 determines whether the person 11b is loaded, and when the person 11b is not loaded (step S539: NO), the first moving body 20 repeats step S539.

When the person 11b is loaded (step S539: YES), the first moving body 20 transmits, to the server 50, information indicating that the person 11b is loaded (step S540), and the first moving body 20 proceeds to step S542.

When the server 50 receives the information indicating that the person 11b is loaded in the first moving body 20, the server 50 transmits the information to the third notification unit 73 (step S541). When the third notification unit 73 receives the information indicating that the person 11b is loaded in the first moving body 20, the third notification unit 73 notifies the system administrator C of the information indicating that the person 11b is loaded in the first moving body 20. Accordingly, the system administrator C can recognize that the person 11b is loaded in the first moving body 20. The information may be transmitted from the first moving body 20 to the third notification unit 73 via the communication network 80 without passing through the server 50.

In step S542, the first moving body 20 acquires, by the transport object state acquisition unit 25, the information on the state of the person 11b loaded in the first moving body 20, and transmits the information to the server 50. The information on the state of the person 11b loaded in the accommodating portion 22 of the first moving body 20 is acquired.

When step S542 is executed and the information on the state of the person 11b loaded in the first moving body 20 is received, the server 50 proceeds to step S543, and in the harmful degree determination unit 53, executes the harmful degree determination process of the person 11b loaded at the third point P6, and acquires the harmful degree H of the person 11b to the other person 11. The harmful degree determination process of the person 11b in step S543 is the same as that in the case in which the object 10 in the first embodiment is replaced with the person 11b.

When the harmful degree determination process of the person 11b is completed in step S543, the server 50 transmits the information on the acquired harmful degree H of the person 11b to the second notification unit 72 and the third notification unit 73 (step S544).

The second notification unit 72 notifies the person 11b of a determination result of the harmful degree H of the person 11b in the harmful degree determination process performed by the harmful degree determination unit 53 based on the information on the harmful degree H of the person 11b received from the server 50 when the harmful degree H of the person 11b is equal to or greater than the predetermined threshold value, or information indicating that the harmful degree H of the person 11b is equal to or greater than the predetermined threshold value. For example, when the harmful degree H of the person 11b received from the server 50 is equal to or greater than the predetermined threshold value, the second notification unit 72 may display the determination result of the harmful degree of the person 11b received from the server 50 on the display screen indicating the harmful degree of the person 11b.

The third notification unit 73 notifies the system administrator C of the determination result of the harmful degree of the person 11b in the harmful degree determination process performed by the harmful degree determination unit 53 based on the information on the harmful degree H of the person 11b received from the server 50 when the harmful degree H of the person 11b is equal to or greater than the predetermined threshold value, or the information indicating that the harmful degree H of the person 11b is equal to or greater than the predetermined threshold value. For example, when the harmful degree H of the person 11b received from the server 50 is equal to or greater than the predetermined threshold value, the third notification unit 73 display the determination result of the harmful degree of the person 11b received from the server 50 on the display screen indicating the harmful degree of the person 11b.

Accordingly, when the harmful degree H of the person 11b is equal to or greater than the predetermined threshold value, the person 11b and the system administrator C can recognize the determination result of the harmful degree of the person 11b in the harmful degree determination process in the harmful degree determination unit 53 or the information that the harmful degree H of the person 11b is equal to or greater than the predetermined threshold value.

Subsequently, the server 50 proceeds to step S545, and determines whether the number of persons 11 loaded in the accommodating portion 22 of the first moving body 20 has reached the accommodatable upper limit number of the accommodating portion 22 of the first moving body 20 based on the number of persons 11 loaded in the accommodating portion 22 of the first moving body 20 in the additional loading determination unit 55. When the number of persons 11 loaded in the accommodating portion 22 of the first moving body 20 reaches the accommodatable upper limit number of the accommodating portion 22 of the first moving body 20 (step S545: YES), the server 50 proceeds to step S548, prohibits loading the other person 11 in the first moving body 20, and proceeds to step S551. On the other hand, when the number of persons 11 loaded in the accommodating portion 22 of the first moving body 20 has not reached the accommodatable upper limit number of the accommodating portion 22 of the first moving body 20 (step S545: NO), the server 50 proceeds to step S546.

In step S546, the server 50 determines, in the additional loading determination unit 55, whether the harmful degree H of the person 11b loaded in the first moving body 20, which is determined by the harmful degree determination unit 53, is equal to or greater than the predetermined threshold value based on the harmful degree H of the person 11b loaded in the first moving body 20, which is determined by the harmful degree determination unit 53. The predetermined threshold value of the harmful degree H of the person 11b is, for example, the first threshold value in the harmful degree H according to the first embodiment, that is, the infection risk Hc=4 of the harmful degree H of the person 11b. When the harmful degree H of the person 11b determined by the harmful degree determination unit 53 is equal to or greater than the predetermined threshold value (step S546: YES), the server 50 proceeds to step S548, prohibits loading the other person 11 in the first moving body 20, and proceeds to step S551. On the other hand, in step S546, when the harmful degree H of the person 11a determined by the harmful degree determination unit 53 is less than the predetermined threshold value (step S546: NO), the server proceeds to step S547, permits the other person 11 to be loaded in the first moving body 20, and returns to step S531.

In step S551, the server 50 determines, in the harmed degree determination unit 56, whether the number of persons 11 loaded in the first moving body 20 is two or more. When the number of persons 11 loaded in the first moving body 20 is two or more (step S551: YES), the server 50 proceeds to step S552, and when the number of persons 11 loaded in the first moving body 20 is not two or more (one or less) (step S551: NO), the server 50 proceeds to step S560.

In step S552, the server 50 determines, in the harmed degree determination unit 56, whether the harmful degree H of the person 11 (in the present embodiment, the person 11b) loaded most recently in the first moving body 20, which is determined by the harmful degree determination unit 53, is equal to or greater than the predetermined threshold value. The predetermined threshold value of the harmful degree H of the person 11b is, for example, the first threshold value in the harmful degree H according to the first embodiment, that is, the infection risk Hc=4 of the harmful degree H of the person 11b. When the harmful degree H of the person 11 (in the present embodiment, the person 11b) loaded most recently in the first moving body 20, which is determined by the harmful degree determination unit 53, is less than the predetermined threshold value (step S552: NO), the process proceeds to step S560. When the harmful degree H of the person 11 (in the present embodiment, the person 11b) loaded most recently in the first moving body 20, which is determined by the harmful degree determination unit 53, is equal to or greater than the predetermined threshold value (step S552: YES), the process proceeds to step S553.

In step S553, the server 50 executes the harmed degree determination process in the harmed degree determination unit 56, and acquires the harmed degree D of the person 11a loaded in the first moving body 20. Details of the harmed degree determination process of the person 11a in step S553 will be described later.

Accordingly, since it is possible to determine the harmed degree D of the person 11a loaded in the first moving body 20 at the first point P4 harmed by the person 11b loaded in the first moving body 20 at the third point P6, when there is the harmful factor in the person 11b loaded in the first moving body 20 at the third point P6, it is possible to determine the harmed degree D of the person 11a loaded in the first moving body 20 at the first point P4 harmed by the person 11b loaded in the first moving body 20 at the third point P6.

When the harmed degree determination process of the person 11a is completed in step S553, the server 50 transmits the information on the acquired harmed degree D of the person 11a to the first notification unit 71 and the third notification unit 73 (step S554).

The first notification unit 71 notifies the person 11a of the determination result of the harmed degree D of the person 11a in the harmed degree determination process performed by the harmed degree determination unit 56 based on the information on the harmed degree D of the person 11a received from the server 50 when the harmed degree D of the person 11a is equal to or greater than the predetermined threshold value, or the information indicating that the harmed degree D of the person 11a is equal to or greater than the predetermined threshold value. For example, when the harmed degree D of the person 11a received from the server 50 is equal to or greater than the predetermined threshold value, the first notification unit 71 may display the determination result of the harmed degree of the person 11a received from the server 50 on the display screen indicating the harmed degree of the person 11a.

The third notification unit 73 notifies the system administrator C of the determination result of the harmed degree of the person 11a in the harmed degree determination process performed by the harmed degree determination unit 56 based on the information on the harmed degree D of the person 11a received from the server 50 when the harmed degree D of the person 11a is equal to or greater than the predetermined threshold value, or the information indicating that the harmed degree D of the person 11a is equal to or greater than the predetermined threshold value. For example, when the harmed degree D of the person 11a received from the server 50 is equal to or greater than the predetermined threshold value, the third notification unit 73 display the determination result of the harmed degree of the person 11a received from the server 50 on the display screen indicating the harmed degree of the person 11a.

Accordingly, when the harmed degree D of the person 11a is equal to or greater than the predetermined threshold value, the person 11a and the system administrator C can recognize the determination result of the harmed degree of the person 11a in the harmed degree determination process in the harmed degree determination unit 56 or the information that the harmed degree D of the person 11a is equal to or greater than the predetermined threshold value.

Subsequently, the server 50 proceeds to step S560, and executes, in the transport plan creation unit 54, the transport plan creation process based on the harmful degree H of the person 11a acquired in step S513, the harmful degree H of the person 11b acquired in step S543, and the harmed degree D of the person 11a acquired in step S553, and creates the transport plan for the person 11a and the person 11b. In the present embodiment, the transport plan in which respective destinations of the person 11a and the person 11b are designated is created by the transport plan creation process (step S560). Further, in the present embodiment, the transport plan for the person 11a and the person 11b created by the transport plan creation process (step S560) includes a transport plan #1 in which the person 11b is not loaded and the destination of the person 11a is set to the second point P5, a transport plan #2 in which the person 11b is not loaded and the destination of the person 11a is set to the medical institution M, a transport plan #3 in which the person 11a and the person 11b are loaded and the destination of the person 11a is set to the second point P5, and the destination of the person 11b is set to the fourth point P7, a transport plan #4 in which the person 11a and the person 11b are loaded, the destination of the person 11a is set to the second point P5, and the destination of the person 11b is set to the medical institution M, and a transport plan #5 in which the person 11a and the person 11b are loaded, the destination of the person 11a and the destination of the person 11b are set to the medical institution M. Details of the transport plan creation process in step S560 will be described later.

Accordingly, based on the harmful degree H of the person 11a acquired in step S513, the harmful degree H of the person 11b acquired in step S543, and the harmed degree D of the person 11a acquired in step S553, it is possible to create the transport plan for preventing the harmful factor from spreading through the medium of the person 11 loaded in the first moving body 20 when the harmful factor is present in the person 11 loaded in the first moving body 20.

When the transport plan creation process in step S560 is completed, the server 50 transmits the information on the created transport plan to the first notification unit 71, the second notification unit 72, and the third notification unit 73 (step S571). The server 50 may transmit the created transport plan to the first notification unit 71, the second notification unit 72, and the third notification unit 73, may transmit, to the first notification unit 71, information indicating a transport destination of the person 11a in the created transport plan, may transmit, to the second notification unit 72, information indicating a transport destination of the person 11b in the created transport plan, and may transmit, to the third notification unit 73, the information indicating the transport destination of the person 11a in the created transport plan and the information indicating the transport destination of the person 11b.

Accordingly, the person 11a and the person 11b can at least recognize their own transport destinations, and the system administrator C can at least recognize the transport destination of each of the person 11a and the person 11b.

Subsequently, the server 50 proceeds to step S572, and creates the movement plan for the first moving body 20 based on the transport plan created in the transport plan creation process in step S560 in the transport plan creation unit 54, the various information stored in the environment information database 52, the various information such as position information and a moving state transmitted from the first moving body 20, an energy storage state of the mounted energy storage device, and a loading time of the person 11 loaded in the past.

For example, based on map information stored in the environment information database 52 and the transport destination of each of the person 11a and the person 11b in the transport plan created in the transport plan creation process in step S560, the movement plan for the first moving body 20 in which an arrival order is adjusted such that a moving distance is the shortest may be created. Further, based on infectious disease epidemic information stored in the environment information database 52 and position information transmitted from the first moving body 20, the movement plan for the first moving body 20 may be created so as to obtain a path for avoiding a region in which the infectious disease is epidemic.

When creation of the movement plan for the first moving body 20 in step S572 is completed, the server 50 transmits the movement plan for the first moving body 20 created in step S572 to the first moving body 20 (step S573). When the first moving body 20 receives the movement plan for the first moving body 20 from the server 50, the first moving body 20 starts moving toward the transport destination according to the received movement plan for the first moving body 20 (step S574).

Further, when the first moving body 20 arrives at the transport destination of the person 11a, the first moving body 20 transmits, to the server 50, information indicating that the first moving body 20 has arrived at the transport destination of the person 11a (step S575). Thus, the server 50 transmits, to the first notification unit 71 and the third notification unit 73, the information indicating that the first moving body 20 has arrived at the transport destination of the person 11a (step S576). When the first notification unit 71 receives the information indicating that the first moving body 20 has arrived at the transport destination of the person 11a, the first notification unit 71 notifies the person 11a that the first moving body 20 has arrived at the transport destination of the person 11a. Accordingly, the person 11a recognizes that the first moving body 20 has arrived at the transport destination thereof, and can get out of the first moving body 20. When the third notification unit 73 receives the information indicating that the first moving body 20 has arrived at the transport destination of the person 11a, the third notification unit 73 notifies the system administrator C that the first moving body 20 has arrived at the transport destination of the person 11a. Accordingly, the system administrator C can recognize that the first moving body 20 has arrived at the transport destination of the person 11a.

Further, when the first moving body 20 arrives at the transport destination of the person 11b, the first moving body 20 transmits, to the server 50, information indicating that the first moving body 20 has arrived at the transport destination of the person 11b (step S577). Thus, the server 50 transmits, to the second notification unit 72 and the third notification unit 73, the information indicating that the first moving body 20 has arrived at the transport destination of the person 11b (step S578). When the second notification unit 72 receives the information indicating that the first moving body 20 has arrived at the transport destination of the person 11b, the second notification unit 72 notifies the person 11b that the first moving body 20 has arrived at the transport destination of the person 11b. Accordingly, the person 11b recognizes that the first moving body 20 has arrived at the transport destination thereof, and can get out of the first moving body 20. When the third notification unit 73 receives the information indicating that the first moving body 20 has arrived at the transport destination of the person 11b, the third notification unit 73 notifies the system administrator C that the first moving body 20 has arrived at the transport destination of the person 11b. Accordingly, the system administrator C can recognize that the first moving body 20 has arrived at the transport destination of the person 11b.

Further, when the first moving body 20 arrives at a final point of the movement plan for the first moving body 20 created in step S572 and the transporting of the person 11a and the person 11b is completed, the first moving body 20 transmits, to the server 50, information indicating that the transporting of the person 11a and the person 11b has been completed (step S579).

When the server 50 receives the information indicating that the transporting of the person 11a and the person 11b has been completed, the server 50 transmits the information to the third notification unit 73 (step S580). When the third notification unit 73 receives the information indicating that the transporting of the person 11a and the person 11b has been completed, the third notification unit 73 notifies the system administrator C of the information indicating that the transporting of the person 11a and the person 11b has been completed. Accordingly, the system administrator C can recognize that the transporting of the person 11a and the person 11b has been completed. The information may be transmitted from the first moving body 20 to the third notification unit 73 via the communication network 80 without passing through the server 50.

The server 50 proceeds to step S581 upon receiving the information from the first moving body 20 indicating that the transporting of the person 11a and the person 11b has been completed.

In step S581, the server 50 executes the harmful degree determination process of the first moving body 20 in the harmful degree determination unit 53, and determines the harmful degree Hm of the first moving body 20 in which the person 11a and the person 11b are loaded. For example, in the harmful degree determination process of the first moving body 20, the harmful degree Hm of the first moving body 20 in which the person 11a and the person 11b are loaded is determined based on the harmful degree H of the person 11a acquired in step S513, the harmful degree H of the person 11b acquired in step S543, the harmed degree D of the person 11a acquired in step S553, the loading time of the person 11a and the person 11b in the first moving body 20, the movement history of the first moving body 20, the map information stored in the environment information database 52, the infectious disease epidemic information, and the like.

Further, when the harmful degree determination process of the first moving body 20 in step S581 is completed, the series of processes is ended.

(Harmed Degree Determination Process)

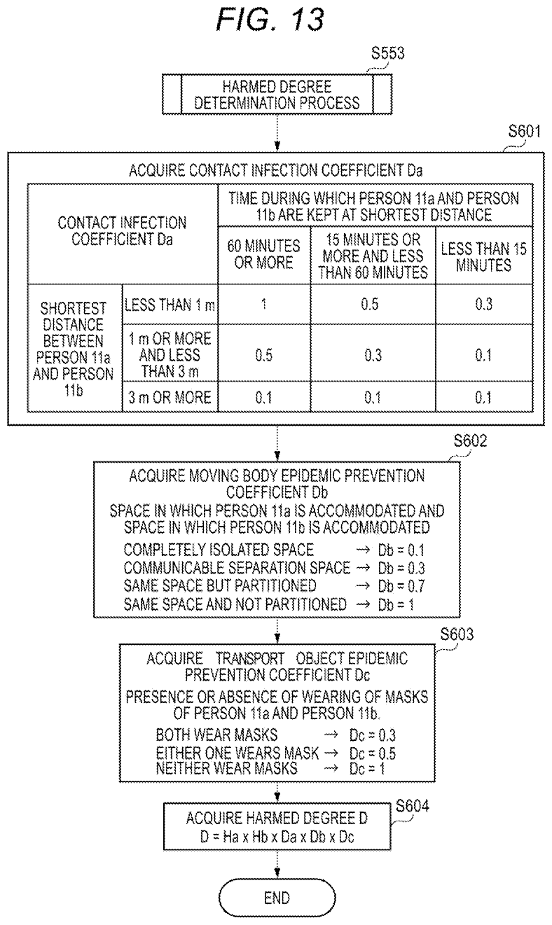

Next, in the present embodiment, an example of the harmed degree determination process of the person 11a performed by the harmed degree determination unit 56 in step S553 will be described with reference to FIG. 13.

The harmed degree determination unit 56 according to the present embodiment determines the harmed degree D based on at least one of the harmful degree H of the person 11b loaded in the first moving body 20, which is determined by the harmful degree determination unit 53, epidemic prevention states of the person 11a and the person 11b loaded in the first moving body 20, the epidemic prevention state of the first moving body 20, a loading time during which both the person 11a and the person 11b loaded in the first moving body 20 are loaded in the first moving body 20 at the same time, a loading distance that both the person 11a and the person 11b loaded in the first moving body 20 travel while being in the first moving body 20 at the same time, a shortest distance in the first moving body 20 between the person 11a and the person 11b loaded in the first moving body 20, and a time during which the person 11a and the person 11b loaded in the first moving body 20 are kept at the shortest distance.

As illustrated in FIG. 13, in the harmed degree determination process, the harmed degree determination unit 56 first acquires a contact infection coefficient Da (step S601). The harmed degree determination unit 56 includes a contact infection coefficient table, and the contact infection coefficient Da is acquired with reference to the contact infection coefficient table. The contact infection coefficient table includes the shortest distance between the person 11a and the person 11b and the time during which the person 11a and the person 11b are kept at the shortest distance.

In the present embodiment, in the contact infection coefficient table, the shortest distance between the person 11a and the person 11b is divided into three categories: less than 1 [m], 1 [m] or more and less than 3 [m], and 3 [m] or more, and the time during which the person 11a and the person 11b are kept at the shortest distance is divided into three categories: 60 [minutes] or more, 15 [minutes] or more and less than 60 [minutes], and less than 15 [minutes].

Further, when the shortest distance between the person 11a and the person 11b is less than 1 [m] and the time during which the person 11a and the person 11b are kept at the shortest distance is 60 [minutes] or more, the contact infection coefficient Da is set to 1, when the shortest distance between the person 11a and the person 11b is less than 1 [m], and the time during which the person 11a and the person 11b are kept at the shortest distance is 15 [minutes] or more and less than 60 [minutes], the contact infection coefficient Da is set to 0.5, when the shortest distance between the person 11a and the person 11b is less than 1 [m], and the time during which the person 11a and the person 11b are kept at the shortest distance is less than 15 [minutes], the contact infection coefficient Da is set to 0.3. When the shortest distance between the person 11a and the person 11b is 1 [m] or more and less than 3 [m] and the time during which the person 11a and the person 11b are kept at the shortest distance is 60 [minutes] or more, the contact infection coefficient Da is set to 0.5, when the shortest distance between the person 11a and the person 11b is 1 [m] or more and less than 3 [m] and the time during which the person 11a and the person 11b are kept at the shortest distance is 15 [minutes] or more and less than 60 [minutes], the contact infection coefficient Da is set to 0.3, when the shortest distance between the person 11a and the person 11b is 1 [m] or more and less than 3 [m] and the time during which the person 11a and the person 11b are kept at the shortest distance is less than 15 [minutes], the contact infection coefficient Da is set to 0.1. When the shortest distance between the person 11a and the person 11b is 3 [m] or more, Da is set to 0.1.

Next, the process proceeds to step S602, and the harmed degree determination unit 56 acquires a moving body epidemic prevention coefficient Db based on the epidemic prevention state of the first moving body 20. One example of the epidemic prevention state of the first moving body 20 is an isolation degree between the person 11a and the person 11b in the accommodating portion 22. Inside the accommodating portion 22, the moving body epidemic prevention coefficient Db is, for example, Db=0.1 when a space in which the person 11a is accommodated and a space in which the person 11b is accommodated are completely isolated from each other, Db=0.3 when the space in which the person 11a is accommodated and the space in which the person 11b is accommodated are separated by a door or the like but are communicable with each other, Db=0.7 when the space in which the person 11a is accommodated and the space in which the person 11b is accommodated are the same space, but the person 11a and the person 11b are partitioned by a screen or the like, and Db=1 when the space in which the person 11a is accommodated and the space in which the person 11b is accommodated are the same space, and are not especially partitioned by the screen or the like.

Next, the process proceeds to step S603, and the harmed degree determination unit 56 acquires a transport object epidemic prevention coefficient Dc based on the epidemic prevention states of the person 11a and the person 11b loaded in the first moving body 20. One example of the epidemic prevention states of the person 11a and the person 11b loaded in the first moving body 20 is the presence or absence of wearing of a mask of each of the person 11a and the person 11b. The transport object epidemic prevention coefficient Dc is, for example, Dc=0.3 when both the person 11a and the person 11b wear masks, Dc=0.5 when only one of the person 11a and the person 11b wears the mask, and Dc=1 when neither the person 11a nor the person 11b is wearing the mask.

Further, the processing proceeds to step S604, and the harmed degree determination unit 56 acquires the harmed degree D of the person 11a based on the harmful degree H of the person 11b acquired in step S553, the contact infection coefficient Da acquired in step S601, the moving body epidemic prevention coefficient Db acquired in step S602, and the transport object epidemic prevention coefficient Dc acquired in step S603. The harmed degree D of the person 11a is acquired as a value obtained by multiplying the infection risk Hc=Ha×Hb at the harmful degree H of the person 11b acquired in step S553 by the contact infection coefficient Da, the moving body epidemic prevention coefficient Db, and the transport object epidemic prevention coefficient Dc. That is, the harmed degree D of the person 11a is acquired as a value given by D=Ha×Hb×Da×Db×Dc.

(Conveyance Plan Creation Process)

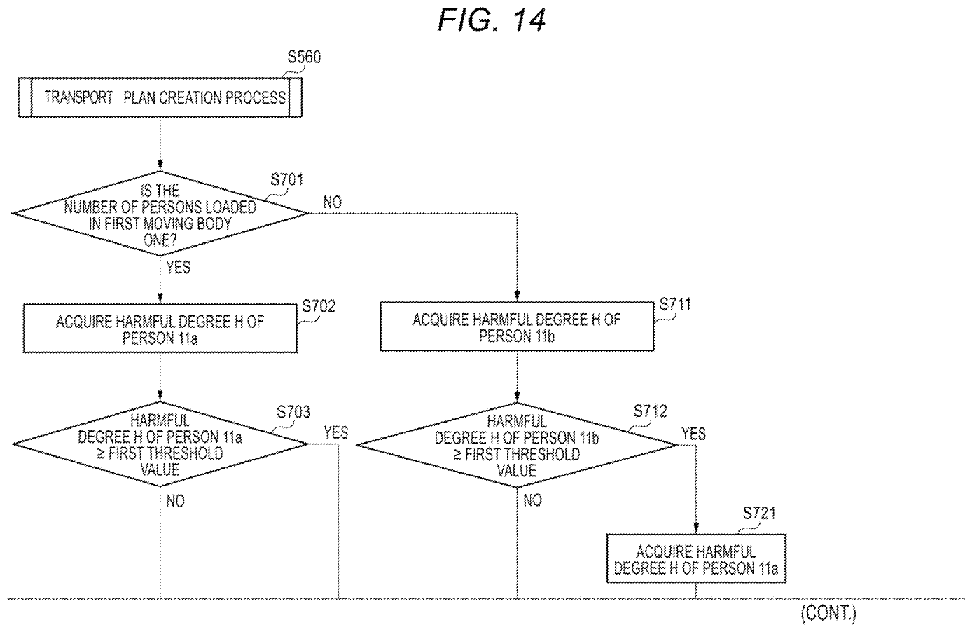

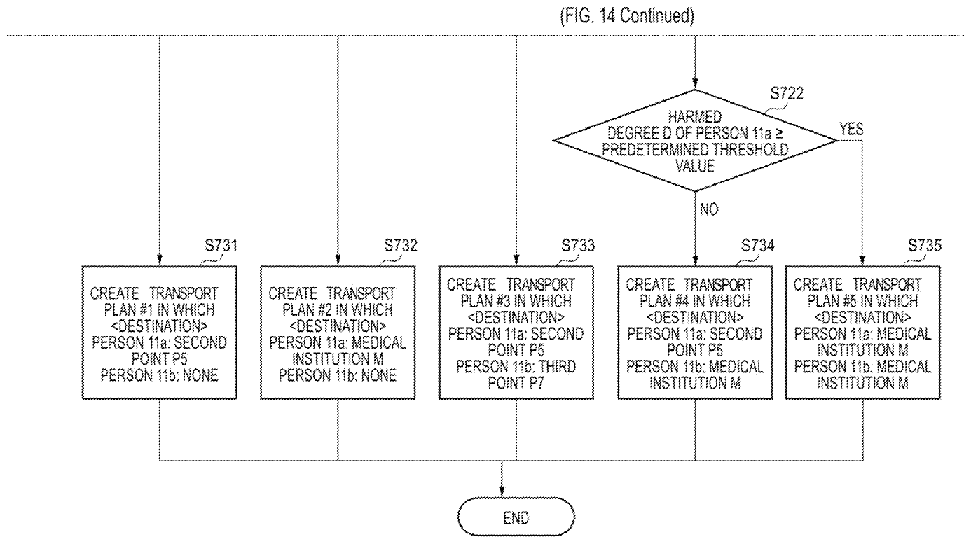

Next, an example of the transport plan creation process of the person 11a and the person 11b in step S560 described above will be described with reference to FIG. 14. The transport plan creation process of the person 11a and the person 11b is executed by the transport plan creation unit 54 of the server 50. The transport plan creation process of the person 11a and the person 11b to be described below is an example, and any transport plan creation process may be executed to create the transport plan for the person 11 loaded in the first moving body 20.

As illustrated in FIG. 14, in the transport plan creation process, the transport plan creation unit 54 first determines whether the number of the persons 11 loaded in the first moving body 20 is one (that is, only the person 11a) (step S701). When the number of the persons 11 loaded in the first moving body 20 is one (that is, only the person 11a) (step S701: YES), the process proceeds to step S702, and when the number of the persons 11 loaded in the first moving body 20 is not one (that is, the person 11a and the person 11b are loaded in the first moving body 20) (step S701: NO), the process proceeds to step S711.

In step S702, the transport plan creation unit 54 acquires, from the harmful degree determination unit 53, the harmful degree H of the person 11a acquired in the above-described harmful degree determination process.

Subsequently, the transport plan creation unit 54 proceeds to step S703, and determines whether the acquired harmful degree H of the person 11a is equal to or greater than the first threshold value. In the present embodiment, the first threshold value is the infection risk Hc=4 (see FIG. 5).

When the acquired harmful degree H of the person 11a is less than the first threshold value (step S703: NO), the transport plan creation unit 54 creates the transport plan #1 in which the person 11b is not loaded and the destination of the person 11a is set to the second point P5 (step S731), and ends the transport plan creation process. The transport plan #1 is a transport plan in which the person 11b is not loaded and the person 11a is transported to the second point P5.

Accordingly, when the harmful degree H of the person 11a is estimated to be low, that is, when it is estimated that the person 11a is not infected with the infectious disease or the like and is normal, the person 11a can be efficiently transported to the second point P5.

On the other hand, when the acquired harmful degree H of the person 11a is equal to or greater than the first threshold value (step S703: YES), the transport plan creation unit 54 creates the transport plan #2 in which the person 11b is not loaded and the destination of the person 11a is set to the medical institution M (step S732), and ends the transport plan creation process. The transport plan #2 is a transport plan in which the person 11b is not loaded and the person 11a is transported to the medical institution M.

Accordingly, when the harmful degree H of the person 11a is equal to or greater than the first threshold value, that is, when it is estimated that a probability that the person 11a is infected with the infectious disease or the like is high, it is possible to transport the person 11a to the medical institution M, and thus it is possible to prevent the harmful factor such as a virus and a bacterium from spreading through the medium of the person 11a.

In step S711, the transport plan creation unit 54 acquires, from the harmful degree determination unit 53, the harmful degree H of the person 11b acquired in the above-described harmful degree determination process.

Subsequently, the transport plan creation unit 54 proceeds to step S712, and determines whether the acquired harmful degree H of the person 11b is equal to or greater than the first threshold value. In the present embodiment, the first threshold value is the infection risk Hc=4 (see FIG. 5).

When the acquired harmful degree H of the person 11b is less than the first threshold value (step S712: NO), the transport plan creation unit 54 creates the transport plan #3 in which the person 11a and the person 11b are loaded, the destination of the person 11a is set to the second point P5, and the destination of the person 11b is set to the fourth point P7 (step S733), and ends the transport plan creation process. The transport plan #3 is a transport plan in which the person 11a and the person 11b are loaded, the person 11a is transported to the second point P5, and the person 11b is transported to the fourth point P7.

Accordingly, when it is estimated that the harmful degrees H of the person 11a and the person 11b are low, that is, when it is estimated that the person 11a and the person 11b are not infected with the infectious disease or the like and are normal, the person 11a and the person 11b can be efficiently transported to the second point P5 and the fourth point P7, respectively. In the present embodiment, as described above, when the harmful degree H of the person 11a is equal to or greater than the first threshold value, the person 11b is prohibited from being loaded in the first moving body 20, and thus the harmful degree H of the person 11a is less than the first threshold value when the person 11b is loaded.

On the other hand, when the acquired harmful degree H of the person 11b is equal to or greater than the first threshold value (step S712: YES), the transport plan creation unit 54 proceeds to step S721, and acquires the harmed degree D of the person 11a acquired in the harmed degree determination process described above from the harmed degree determination unit 56.

Further, the transport plan creation unit 54 proceeds to step S722, and determines whether the harmed degree D of the person 11a is equal to or greater than the predetermined threshold value. In the present embodiment, the predetermined threshold value of the harmed degree D is D=1.

When the harmed degree D of the person 11a is less than the predetermined threshold value (step S722: NO), the transport plan creation unit 54 creates the transport plan #4 in which the person 11a and the person 11b are loaded, the destination of the person 11a is set to the second point P5, and the destination of the person 11b is set to the medical institution M (step S734), and ends the transport plan creation process. The transport plan #4 is a transport plan in which the person 11a and the person 11b are loaded, the person 11a is transported to the second point P5, and the person 11b is transported to the medical institution M.

Accordingly, when a probability that the person 11b is infected with the infectious disease or the like is estimated to be high, and a probability that the person 11a is infected with the infectious disease or the like from the person 11b is estimated to be low, the person 11a can be transported to the second point P5 while the person 11b is transported to the medical institution M, so that it is possible to transport the person 11a to the second point P5 while preventing the harmful factor such as a virus and a bacterium from spreading through the medium of the person 11b.

On the other hand, when the harmed degree D of the person 11a is equal to or greater than the predetermined threshold value (step S722: YES), the transport plan creation unit 54 creates the transport plan #5 in which the person 11a and the person 11b are loaded and the destination of the person 11a and the destination of the person 11b are the medical institution M (step S735), and ends the transport plan creation process. The transport plan #5 is a transport plan in which the person 11a and the person 11b are loaded and both the person 11a and the person 11b are transported to the medical institution M.

Accordingly, when the probability that the person 11b is infected with the infectious disease or the like is estimated to be high and the probability that the person 11a is infected with the infectious disease or the like from the person 11b is estimated to be high, it is possible to transport both the person 11a and the person 11b to the medical institution M. and thus it is possible to prevent the harmful factor such as a virus and a bacterium from spreading through media of the person 11a and the person 11b.

Although the embodiments of the present invention have been described above with reference to the accompanying drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, respective constituent elements in the above embodiments may be freely combined without departing from the gist of the invention.

For example, in the first embodiment and the second embodiment, the object 10 is the package such as an article, but the object 10 may be the energy storage device mounted on the first moving body 20 or a human (person) as in the third embodiment. Further, in the case in which the object 10 is the human (person), the sender state acquisition unit 24 may be an information terminal that can be input by the object 10 and includes the display device, and may acquire information on a state of the object 10 based on information input by the object 10 with respect to the question item displayed on the display device.

The transport object state acquisition unit 25 may indirectly acquire the state of the object 10 based on a temperature, humidity, a pressure, and the like inside the accommodating portion 22.

Further, the sender A may be a person or a machine or a device such as a forklift or an actuator.

Further, the receiver B may be a person or a machine or device such as a forklift or an actuator.

In the first to third embodiments, the first moving body 20 is an autonomous mobile vehicle, but the first moving body 20 may be an autonomous moving body other than the vehicle, and may be, for example, an aircraft, a ship, or a general-purpose device. Further, as a moving path of the first moving body 20, any path can be adopted, and for example, a path on the ground, in the air, on the sea, in the water, in space, or the like can be adopted.

In the first to third embodiments, the first moving body 20 is a moving body that is movable autonomously, but may not be movable autonomously, and may be a vehicle that moves by an operation of an operator of the first moving body 20. The operator of the first moving body 20 may be in the first moving body 20 or outside the first moving body 20. In this case, for example, in the first embodiment, the server 50 transmits the movement plan for the first moving body 20 created in step S19 in the transport plan creation unit 54 to the operator of the first moving body 20. Further, in step S20, the operator of the first moving body 20 performs an operation according to the movement plan for the first moving body 20 transmitted from the server 50, so that the first moving body 20 starts moving toward the through point or the destination.

The first moving body 20 may not include the swing door 23, and the accommodating portion 22 may be always accessible from an outside of the first moving body 20. For example, the accommodating portion 22 is a space surrounded by an annular wall formed in an annular shape, and both ends or one end of the annular wall portion may be opened to the outside.

The second moving body 30 may not include the swing door 33, and the accommodating portion 32 may be always accessible from an outside of the second moving body 30. For example, the accommodating portion 32 is a space surrounded by an annular wall formed in an annular shape, and both ends or one end of the annular wall portion may be opened to the outside. Further, the second moving body 30 may not include the accommodating portion 32, may be capable of connecting the plurality of first moving bodies 20, and may be able to draw the connected first moving bodies 20.

The second moving body 30 may be omitted. That is, the system 1 may not include the second moving body 30.

The harmful degree determination unit 53 and the transport plan creation unit 54 are provided in the server 50, but may be provided in the first moving body 20. That is, in the first embodiment and the second embodiment, the server 50 is a harmful degree determination device including the harmful degree determination unit 53, but the first moving body 20 may be a harmful degree determination device including the harmful degree determination unit 53.

In the third embodiment, the transport object state acquisition unit 25 may include a camera, a microphone, or the like. Further, the server 50 accumulates person specification information for specifying the person 11, and the transport object state acquisition unit 25 may acquire, by a camera, a microphone, or the like, face information, appearance information, action information, voice information, and the like of the person 11 loaded in the first moving body 20, and specify the person 11 loaded in the first moving body 20 by referring to these information and the person specification information accumulated in the server 50, or may estimate the health condition and a mental state of the person 11 based on the action information.

In the third embodiment, the transport object state acquisition unit 25 is mounted on the first moving body 20, but the transport object state acquisition unit 25 may be mounted on the personal digital assistant such as a smartphone owned by the person 11a together with the first notification unit 71, or may be mounted on the personal digital assistant such as a smartphone owned by the person 11b together with the second notification unit 72.

In the third embodiment, in step S532, the server 50 determines whether the first moving body 20 passes through the third point P6 based on the position information and the moving state transmitted from the personal digital assistant such as a smartphone owned by the person 11a on which the first notification unit 71 is mounted, and the position information and the moving state transmitted from the personal digital assistant such as a smartphone owned by the person 11b on which the second notification unit 72 is mounted in addition to the various information stored in the environment information database 52, the various information such as position information and a moving state transmitted from the first moving body 20, an energy storage state of the mounted energy storage device, and the presence or absence of the loading of the other person 11, and the determination result of the additional loading determination unit 55.

The transporting of the object 10 shown in the first embodiment and the second embodiment may be performed by executing a transporting program capable of executing the processing operation of the system for transporting the object described in the first embodiment to the third embodiment.

The transporting program capable of executing the processing operation of the system for transporting the object described in the first to third embodiments may be stored in a storage medium. Accordingly, the transporting program stored in the storage medium is read by a computer, so that the transporting program can be easily executed.

In the present specification, at least the following matters are described. In the parentheses, the corresponding constituent elements and the like in the above embodiments are shown as an example, but the present invention is not limited thereto.

(A1) A system for transporting an object (system 1 for transporting an object) that transports a object (transport object 10) loaded in a moving body (first moving body 20) at a first point (first point P1), the system including:
a harmful degree determination unit (harmful degree determination unit 53) configured to determine a harmful degree (harmful degree H) to a living organism of the object loaded in the moving body.

According to (A1), since the system can determine the harmful degree of the object to the living organism, when there is the harmful factor in the object, it is possible to prevent the harmful factor from spreading through the medium of the object.

(A2) The system according to (A1), further including:
a transport plan creation unit (transport plan creation unit 54) configured to create a transport plan for the object based on the harmful degree of the object determined by the harmful degree determination unit.

According to (A2), the system can create the transport plan for the object based on the harmful degree of the object determined by the harmful degree determination unit, and thus the system can create the transport plan for preventing the harmful factor from spreading through the medium of the object when there is the harmful factor in the object.

(A3) The system according to (A2), in which
the transport plan creation unit creates the transport plan for reducing the harmful degree of the object when the harmful degree of the object determined by the harmful degree determination unit is equal to or greater than a first threshold value.

According to (A3), when the harmful degree of the object determined by the harmful degree determination unit is equal to or greater than the first threshold value, it is possible to transport the object to the second point after the harmful degree of the object is reduced, and thus it is possible to prevent the harmful factor from spreading through the medium of the object.

(A4) The system according to (A2) or (A3), in which
the system is capable of transporting the object loaded in the moving body at the first point to a second point (second point P2), and
the transport plan creation unit creates the transport plan for aborting transporting of the object to the second point when the harmful degree of the object determined by the harmful degree determination unit is equal to or greater than a second threshold value.

According to (A4), when the harmful degree of the object determined by the harmful degree determination unit is equal to or greater than the second threshold value, transporting of the object to the second point can be aborted, and thus it is possible to more reliably prevent the harmful factor from spreading through the medium of the object due to transporting of the object to the second point, when the harmful degree of the object is high.

(A5) The system according to any one of (A2) to (A4), in which
the transport plan creation unit creates the transport plan for discarding the object when the harmful degree of the object determined by the harmful degree determination unit is equal to or greater than a third threshold value.

According to (A5), when the harmful degree of the object determined by the harmful degree determination unit is equal to or greater than the third threshold value, the object is discarded, and thus it is possible to more reliably prevent the harmful factor from spreading through the medium of the object, when the harmful degree of the object is high.

(A6) The system according to (A2) or (A3), in which
the system is capable of transporting the object loaded in the moving body at the first point to a second point (second point P2), and the transport plan creation unit creates the transport plan including transporting of the object to the second point.

According to (A6), it is possible to transport the object to the second point after the harmful degree to the living organism of the object loaded in the moving body is determined.

(A7) The system according to any one of (A2) to (A6), further including:
a notification unit (first notification unit 71, second notification unit 72, and third notification unit 73) configured to notify at least one of a sender (sender A) of the object, a receiver (receiver B) of the object, and an administrator (system administrator C) of the system, in which
the notification unit notifies of at least a part of the transport plan created by the transport plan creation unit.

According to (A7), at least one of the sender of the object, the receiver of the object, and the administrator of the system can recognize at least a part of the transport plan created by the transport plan creation unit.

(A8) The system according to any one of (A2) to (A7), in which
the transport plan creation unit further creates a movement plan for the moving body based on the created transport plan.

According to (A8), it is possible to create the movement plan for the moving body so as to prevent the harmful factor from spreading through the medium of the object, based on the transport plan created by the transport plan creation unit.

(A9) The system according to any one of (A1) to (A8), further including:
a sender state acquisition unit (sender state acquisition unit 24) configured to acquire information on a state of a sender (sender A) who has put the object in the moving body at the first point.

According to (A9), the information on the state of the sender of the object can be acquired by the sender state acquisition unit.

(A10) The system according to (A9), in which
the harmful degree determination unit determines the harmful degree based on the information on the state of the sender acquired by the sender state acquisition unit.

According to (A10), since the harmful degree determination unit determines the harmful degree of the object based on the information on the state of the sender acquired by the sender state acquisition unit, it is possible to more accurately determine the harmful degree of the object.

(A11) The system according to any one of (A1) to (A10), in which
the moving body includes a transport object state acquisition unit (transport object state acquisition unit 25) configured to acquire information on a state of the object loaded in the moving body.

According to (A11), since the moving body includes the transport object state acquisition unit that acquires the information on the state of the object loaded in the moving body, the information on the state of the object loaded in the moving body can be acquired even during the movement of the moving body.

(A12) The system according to (A11), in which
the harmful degree determination unit determines the harmful degree based on the information on the state of the object acquired by the transport object state acquisition unit.

According to (A12), since the harmful degree determination unit determines the harmful degree of the object based on the information on the state of the object acquired by the transport object state acquisition unit, it is possible to appropriately determine the harmful degree of the object even when the harmful degree of the object is changed during the movement of the moving body.

(A13) The system according to any one of (A1) to (A12), further including:
a notification unit (first notification unit 71, second notification unit 72, and third notification unit 73) configured to notify at least one of a sender (sender A) of the object, a receiver (receiver B) of the object, and an administrator (system administrator C) of the system, in which
when the harmful degree of the object determined by the harmful degree determination unit is equal to or greater than a predetermined threshold value, the notification unit notifies of a determination result of the harmful degree determination unit or information indicating that the harmful degree of the object is equal to or greater than the predetermined threshold value.

According to (A13), at least one of the sender of the object, the receiver of the object, and the administrator of the system can recognize the determination result of the harmful degree of the object in the harmful degree determination process performed by the harmful degree determination unit when the harmful degree of the object is equal to or greater than the predetermined threshold value, and the information indicating that the harmful degree of the object is equal to or greater than the predetermined threshold value.

(A14) The system according to any one of (A1) to (A13), in which
the harmful degree determination unit further determines a harmful degree (harmful degree Hm) to the living organism of the moving body in which the object is loaded.

According to (A14), since the system can determine the harmful degree of the moving body to the living organism, it is possible to prevent the harmful factor from spreading through the medium of the moving body w % ben there is the harmful factor in the moving body.

(A15) A method for transporting an object (transport object 10) loaded in a moving body (first moving body 20) at a first point (first point P1), the method including:
a sender state acquisition step of acquiring information on a state of a sender (sender A) of the object: and
a harmful degree determination step of determining a harmful degree (harmful degree H) to a living organism of the object loaded in the moving body based on the information on the state of the sender acquired in the sender state acquisition step.

According to (A15), in the harmful degree determination step, the harmful degree of the object is determined based on the information on the state of the sender acquired in the sender state acquisition step, and thus it is possible to accurately determine the harmful degree of the object.

(A16) A method for transporting an object (transport object 10) loaded in a moving body (first moving body 20) at a first point (first point P1), the method including:
a transport object state acquisition step of acquiring information on a state of the object loaded in the moving body; and
a harmful degree determination step of determining a harmful degree (harmful degree H) to a living organism of the object loaded in the moving body based on the information on the state of the object acquired in the transport object state acquisition step.

According to (A16), in the harmful degree determination step, the harmful degree to the living organism of the object loaded in the moving body is determined based on the information on the state of the object acquired in the transport object state acquisition step, and thus even when the harmful degree of the object loaded in the moving body is changed during the movement of the moving body, it is possible to appropriately determine the harmful degree of the object.

(A17) The method according to (A15) or (A16), further including:
a transport plan creation step of creating a transport plan for the object based on the harmful degree of the object determined in the harmful degree determination step.

According to (A17), in the transport plan creation step, the transport plan for the object is created based on the harmful degree of the object determined in the harmful degree determination step, and thus it is possible to create the transport plan for preventing the harmful factor from spreading through the medium of the object when there is the harmful factor in the object.

(A18) A program for transporting an object (transport object 10) loaded in a moving body (first moving body 20) at a first point (first point P1), the program configured to execute:
a sender state acquisition process of acquiring information on a state of a sender (sender A) of the object: and
a harmful degree determination process of determining a harmful degree (harmful degree H) to a living organism of the object loaded in the moving body based on the information on the state of the sender acquired in the sender state acquisition process.

According to (A18), in the harmful degree determination process, the harmful degree of the object is determined based on the information on the state of the sender acquired in the sender state acquisition process, and thus it is possible to more accurately determine the harmful degree of the object.

(A19) A program for transporting an object (transport object 10) loaded in a moving body (first moving body 20) at a first point (first point P1), the program configured to execute:
a transport object state acquisition process of acquiring information on a state of the object loaded in the moving body: and
a harmful degree determination process of determining a harmful degree (harmful degree H) to a living organism of the object loaded in the moving body based on the information on the state of the object acquired in the transport object state acquisition process.

According to (A19), in the harmful degree determination process, the harmful degree to the living organism of the object loaded in the moving body is determined based on the information on the state of the object acquired in the transport object state acquisition process, and thus even when the harmful degree of the object loaded in the moving body is changed during the movement of the moving body, it is possible to appropriately determine the harmful degree of the object.

(A20) A storage medium that stores the program according to (A18) or (A19).

According to (A20), the program stored in the storage medium is read by a computer, so that the program can be easily executed.

(A21) A harmful degree determination device (server 50) including:
a harmful degree determination unit (harmful degree determination unit 53) configured to determine a harmful degree to a living organism of a transport object (transport object 10) loaded in a moving body (first moving body 20) at a first point (first point P1).

According to (A21), since the harmful degree determination device can determine the harmful degree to the living organism of the object loaded in the moving body, when there is the harmful factor in the object, it is possible to prevent the harmful factor from spreading through the medium of the object.

(B1) A system (system for transporting an object 1, 1A, 1B) that transports an object (transport object 10) loaded in a moving body (first moving body 20) at a first point (first point P1, P4), the system including:
a harmful degree determination unit (harmful degree determination unit 53) configured to determine a harmful degree (harmful degree H) to a living organism of the object loaded in the moving body.

According to (B1), since the system can determine the harmful degree of the object to the living organism, when there is the harmful factor in the object, it is possible to prevent the harmful factor from spreading through the medium of the object.

(B2) The system according to (B1), further including:
a transport plan creation unit (transport plan creation unit 54) configured to create a transport plan for the object based on the harmful degree of the object determined by the harmful degree determination unit.

According to (B2), the system can create the transport plan for the object based on the harmful degree of the object determined by the harmful degree determination unit, and thus the system can create the transport plan for preventing the harmful factor from spreading through the medium of the object when there is the harmful factor in the object.

(B3) The system according to (B2), in which
the transport plan creation unit creates the transport plan for reducing the harmful degree of the object when the harmful degree of the object determined by the harmful degree determination unit is equal to or greater than a first threshold value.

According to (B3), when the harmful degree of the object determined by the harmful degree determination unit is equal to or greater than the first threshold value, it is possible to transport the object to the second point after the harmful degree of the object is reduced, and thus it is possible to prevent the harmful factor from spreading through the medium of the object.

(B4) The system according to (B2) or (B3), in which
the system is capable of transporting the object loaded in the moving body at the first point to a second point (second point P2, P5), and
the transport plan creation unit creates the transport plan including transporting of the object to the second point.

According to (B4), it is possible to transport the object to the second point after the harmful degree to the living organism of the object loaded in the moving body is determined.

(B5) The system according to (B2) or (B3), in which
the system is capable of transporting the object loaded in the moving body at the first point to a second point (second point P2, P5), and
the transport plan creation unit creates the transport plan for aborting transporting of the object to the second point when the harmful degree of the object determined by the harmful degree determination unit is equal to or greater than a second threshold value.

According to (B5), when the harmful degree of the object determined by the harmful degree determination unit is equal to or greater than the second threshold value, transporting of the object to the second point can be aborted, and thus it is possible to more reliably prevent the harmful factor from spreading through the medium of the object due to transporting of the object to the second point, when the harmful degree of the object is high.

(B6) The system according to any one of (B2) to (B5), in which
the transport plan creation unit creates the transport plan for discarding the object when the harmful degree of the object determined by the harmful degree determination unit is equal to or greater than a third threshold value.

According to (B6), when the harmful degree of the object determined by the harmful degree determination unit is equal to or greater than the third threshold value, the object is discarded, and thus it is possible to more reliably prevent the harmful factor from spreading through the medium of the object, when the harmful degree of the object is high.

(B7) The system according to any one of (B2) to (B6), further including:
a notification unit (first notification unit 71, second notification unit 72, and third notification unit 73) configured to notify at least one of a sender (sender A) of the object, a receiver (receiver B) of the object, and an administrator (system administrator C) of the system, in which
the notification unit notifies of at least a part of the transport plan created by the transport plan creation unit.

According to (B7), at least one of the sender of the object, the receiver of the object, and the administrator of the system can recognize at least a part of the transport plan created by the transport plan creation unit.

(B8) The system according to any one of (B2) to (B7), in which
the transport plan creation unit further creates a movement plan for the moving body based on the created transport plan.

According to (B8), it is possible to create the movement plan for the moving body so as to prevent the harmful factor from spreading through the medium of the object, based on the transport plan created by the transport plan creation unit.

(B9) The system according to any one of (B1) to (B8), in which
the moving body includes a transport object state acquisition unit (transport object state acquisition unit 25) configured to acquire transport object state information which is information on a state of the object loaded in the moving body.

According to (B9), since the moving body includes the transport object state acquisition unit that acquires the information on the state of the object loaded in the moving body, the information on the state of the object loaded in the moving body can be acquired even during the movement of the moving body.

(B10) The system according to (B9), in which
the harmful degree determination unit determines the harmful degree based on the transport object state information acquired by the transport object state acquisition unit.

According to (B10), since the harmful degree determination unit determines the harmful degree of the object based on the information on the state of the object acquired by the transport object state acquisition unit, it is possible to appropriately determine the harmful degree of the object even when the harmful degree of the object is changed during the movement of the moving body.

(B11) The system according to any one of (B1) to (B10), further including:
a sender state acquisition unit (sender state acquisition unit 24) configured to acquire sender state information which is information on a state of a sender (sender A) who has put the object in the moving body at the first point.

According to (B11), the information on the state of the sender of the object can be acquired by the sender state acquisition unit.

(B12) The system according to (B11), in which
the harmful degree determination unit determines the harmful degree based on the sender state information acquired by the sender state acquisition unit.

According to (B12), since the harmful degree determination unit determines the harmful degree of the object based on the information on the state of the sender acquired by the sender state acquisition unit, it is possible to more accurately determine the harmful degree of the object.

(B13) The system according to any one of (B1) to (B12), further including:
a notification unit (first notification unit 71, second notification unit 72, and third notification unit 73) configured to notify at least one of a sender (sender A) of the object, a receiver (receiver B) of the object, and an administrator (system administrator C) of the system, in which
when the harmful degree of the object determined by the harmful degree determination unit is equal to or greater than a predetermined threshold value, the notification unit notifies of a determination result of the harmful degree determination unit or information indicating that the harmful degree of the object is equal to or greater than the predetermined threshold value.

According to (B13), at least one of the sender of the object, the receiver of the object, and the administrator of the system can recognize the determination result of the harmful degree of the object in the harmful degree determination process performed by the harmful degree determination unit when the harmful degree of the object is equal to or greater than the predetermined threshold value, and the information indicating that the harmful degree of the object is equal to or greater than the predetermined threshold value.

(B14) The system according to any one of (B1) to (B13), in which
the harmful degree determination unit further determines a harmful degree (harmful degree Hm) to the living organism of the moving body in which the object is loaded.

According to (B14), since the system can determine the harmful degree of the moving body to the living organism, it is possible to prevent the harmful factor from spreading through the medium of the moving body when there is the harmful factor in the moving body.

(B15) The system according to any one of (B1) to (B14), in which
the object is a person (person 11), and
the harmful degree determination unit determines a harmful degree to another person of the person loaded in the moving body at the first point.

According to (B15), since the system can determine the harmful degree to the other person of the person which is the object, when there is the harmful factor in the person which is the object, it is possible to prevent the harmful factor from spreading through the medium of the person.

(B16) The system according to (B15), in which
the other person is loaded in the moving body at a third point (third point P6).

According to (B16), the plurality of persons can be transported from the different points as the objects.

(B17) The system according to (B16), in which
when the harmful degree determination unit determines that the harmful degree of the person loaded in the moving body at the first point is equal to or greater than a predetermined threshold value, the system prohibits loading the other person in the moving body at the third point after loading the person at the first point.

According to (B17), in the case in which the harmful degree of the person loaded in the moving body at the first point is high, the other person is prohibited from being loaded in the moving body at the third point, and thus it is possible to prevent the harmful factor in the person loaded in the moving body at the first point from spreading to the other person in the moving body.

(B18) The system according to (B16) or (B17), further including:
a harmed degree determination unit (harmed degree determination unit 56) configured to determine a harmed degree (harmed degree D) of the person loaded in the moving body at the first point harmed by the other person loaded in the moving body at the third point.

According to (B18), it is possible to determine the harmed degree of the person loaded in the moving body at the first point harmed by the other person loaded in the moving body at the third point, and thus, when there is the harmful factor in the other person loaded in the moving body at the third point, it is possible to determine the harmed degree of the person loaded in the moving body at the first point harmed by the other person loaded in the moving body at the third point.

(B19) The system according to (B18), in which the harmed degree determination unit determines the harmed degree based on at least one of
the harmful degree of the person determined by the harmful degree determination unit,
an epidemic prevention state of the person,
an epidemic prevention state of the other person,
an epidemic prevention state of the moving body,
a loading time during which both the person and the other person are loaded in the moving body,
a loading distance that both the person and the other person travel while being in the moving body, and
an approach distance in the moving body between the person and the other person.

According to (B19), it is possible to appropriately determine the harmed degree of the person loaded in the moving body harmed the other person loaded in the moving body.

(B20) The system according to any one of (B1) to (B19), in which
the harmful degree is an infection risk to the living organism from the object as an infection source.

According to (B20), it is possible to determine the infection risk to the living organism from the object as the infection source.

(B21) A method for transporting an object (transport object 10) loaded in a moving body (first moving body 20) at a first point (first point P1), the method including:
a transport object state acquisition step of acquiring information on a state of the object loaded in the moving body; and
a harmful degree determination step of determining a harmful degree (harmful degree H) to a living organism of the object loaded in the moving body based on the information on the state of the object acquired in the transport object state acquisition step.

According to (B21), in the harmful degree determination step, the harmful degree to the living organism of the object loaded in the moving body is determined based on the information on the state of the object acquired in the transport object state acquisition step, and thus even when the harmful degree of the object loaded in the moving body is changed during the movement of the moving body, it is possible to appropriately determine the harmful degree of the object.

(B22) The method according to (B21), further including:
a sender state acquisition step of acquiring sender state information which is information on a state of a sender (sender A) of the object, in which
the harmful degree determination step determines the harmful degree (harmful degree H) to the living organism of the object loaded in the moving body based on the sender state information acquired in the sender state acquisition step.

According to (B22), in the harmful degree determination step, the harmful degree of the object is determined based on the information on the state of the sender acquired in the sender state acquisition step, and thus it is possible to accurately determine the harmful degree of the object.

(B23) The method according to (B21) or (B22), further including:
a transport plan creation step of creating a transport plan for the object based on the harmful degree of the object determined in the harmful degree determination step.

According to (B23), in the transport plan creation step, the transport plan for the object is created based on the harmful degree of the object determined in the harmful degree determination step, and thus it is possible to create the transport plan for preventing the harmful factor from spreading through the medium of the object when there is the harmful factor in the object.

(B24) A program for transporting an object (transport object 10) loaded in a moving body (first moving body 20) at a first point (first point P1), the program configured to execute:
a transport object state acquisition process of acquiring transport object state information which is information on a state of the object loaded in the moving body; and
a harmful degree determination process of determining a harmful degree (harmful degree H) to a living organism of the object loaded in the moving body based on the object state information acquired in the transport object state acquisition process.

According to (B24), in the harmful degree determination process, the harmful degree to the living organism of the object loaded in the moving body is determined based on the information on the state of the object acquired in the transport object state acquisition process, and thus even when the harmful degree of the object loaded in the moving body is changed during the movement of the moving body, it is possible to appropriately determine the harmful degree of the object.

(B25) The program according to (B24), which is configured to execute:
a sender state acquisition process of acquiring sender state information which is information on a state of a sender (sender A) of the object, in which
the harmful degree determination process determines the harmful degree based on the sender state information acquired in the sender state acquisition process.

According to (B25), in the harmful degree determination process, the harmful degree of the object is determined based on the sender state information acquired in the sender state acquisition process, and thus it is possible to more accurately determine the harmful degree of the object.

(B26) A storage medium that stores the program according to (B24) or (B25).

According to (B26), the program stored in the storage medium is read by a computer, so that the program can be easily executed.

(B27) A harmful degree determination device (server 50) including:
a harmful degree determination unit (harmful degree determination unit 53) configured to determine a harmful degree to a living organism of a transport object (transport object 10) loaded in a moving body (first moving body 20) at a first point (first point P1).

According to (B27), since the harmful degree determination device can determine the harmful degree to the living organism of the object loaded in the moving body, when there is the harmful factor in the object, it is possible to prevent the harmful factor from spreading through the medium of the object.

The present application is based on Japan patent application (Japanese Patent Application No. 2021-018508) filed on Feb. 8, 2021, and the contents of which are incorporated herein by reference.

### REFERENCE SIGNS LIST

1, 1A, 1B system for transporting an object
10 transport object
11 person
20 first moving body (moving body)
24 sender state acquisition unit
25 transport object state acquisition unit
50 server (harmful degree determination device)
53 harmful degree determination unit
54 transport plan creation unit
56 harmed degree determination unit
71 first notification unit (notification unit)
72 second notification unit (notification unit)
73 third notification unit (notification unit)
A sender
B receiver
C system administrator (administrator)
D harmed degree
H harmful degree
Hm harmful degree
P1, P4 first point
P2, P5 second point
P6 third point

1. A system for transporting object that transports an object loaded in a moving body at a first point, the system comprising:
a harmful degree determination unit configured to determine a harmful degree to a living organism of the object loaded in the moving body.

2. The system according to claim 1, further comprising:
a transport plan creation unit configured to create a transport plan for the object based on the harmful degree of the object determined by the harmful degree determination unit.

3. The system according to claim 2, wherein
the transport plan creation unit creates the transport plan for reducing the harmful degree of the object when the harmful degree of the object determined by the harmful degree determination unit is equal to or greater than a first threshold value.

4. The system according to claim 2, wherein
the system is capable of transporting the object loaded in the moving body at the first point to a second point, and
the transport plan creation unit creates the transport plan including transporting of the object to the second point.

5. The system according to claim 2, wherein
the system is capable of transporting the object loaded in the moving body at the first point to a second point, and
the transport plan creation unit creates the transport plan for aborting transporting of the object to the second point when the harmful degree of the object determined by the harmful degree determination unit is equal to or greater than a second threshold value.

6. The system for transporting object according to claim 2, wherein
the transport plan creation unit creates the transport plan for discarding the object when the harmful degree of the object determined by the harmful degree determination unit is equal to or greater than a third threshold value.

7. The system according to claim 2, further comprising:
a notification unit configured to notify at least one of a sender of the object, a receiver of the object, and an administrator of the system, wherein
the notification unit notifies of at least a part of the transport plan created by the transport plan creation unit.

8. The system according to claim 2, wherein
the transport plan creation unit further creates a movement plan for the moving body based on the created transport plan.

9. The system according to claim 1, wherein
the moving body includes a transport object state acquisition unit configured to acquire transport object state information which is information on a state of the object loaded in the moving body.

10. The system according to claim 9, wherein
the harmful degree determination unit determines the harmful degree based on the transport object state information acquired by the transport object state acquisition unit.

11. The system according to claim 1, further comprising:
a sender state acquisition unit configured to acquire sender state information which is information on a state of a sender who has put the object in the moving body at the first point.

12. The system according to claim 11, wherein
the harmful degree determination unit determines the harmful degree based on the sender state information acquired by the sender state acquisition unit.

13. The system according to claim 1, further comprising:
a notification unit configured to notify at least one of a sender of the object, a receiver of the object, and an administrator of the system, wherein
when the harmful degree of the object determined by the harmful degree determination unit is equal to or greater than a predetermined threshold value, the notification unit notifies of a determination result of the harmful degree determination unit or information indicating that the harmful degree of the object is equal to or greater than the predetermined threshold value.

14. The system according to claim 1, wherein
the harmful degree determination unit further determines a harmful degree to the living organism of the moving body in which the object is loaded.

15. The system according to claim 1, wherein
the object is a person, and
the harmful degree determination unit determines a harmful degree to another person of the person loaded in the moving body at the first point.

16. The system according to claim 15, wherein
the another person is loaded in the moving body at a third point.

17. The system according to claim 16, wherein
when the harmful degree determination unit determines that the harmful degree of the person loaded in the moving body at the first point is equal to or greater than a predetermined threshold value, the system prohibits loading the another person in the moving body at the third point after loading the person at the first point.

18. The system according to claim 16, further comprising:
a harmed degree determination unit configured to determine a harmed degree of the person loaded in the moving body at the first point harmed by the another person loaded in the moving body at the third point.

19. The system according to claim 18, wherein
the harmed degree determination unit determines the harmed degree based on at least one of
the harmful degree of the person determined by the harmful degree determination unit,
an epidemic prevention state of the person,
an epidemic prevention state of the another person,
an epidemic prevention state of the moving body,
a loading time during which both the person and the another person are loaded in the moving body at the same time,
a loading distance that both the person and the another person travel while being loaded in the moving body at the same time, and
a distance in the moving body between the person and the another person.

20. The system according to claim 1, wherein
the harmful degree is an infection risk to the living organism from the object as an infection source.

21. A method for transporting an object loaded in a moving body at a first point, the method comprising:
a transport object state acquisition step of acquiring transport object state information which is information on a state of the object loaded in the moving body; and
a harmful degree determination step of determining a harmful degree to a living organism of the object loaded in the moving body based on the transport object state information acquired in the transport object state acquisition step.

22. The method according to claim 21, further comprising:
a sender state acquisition step of acquiring sender state information which is information on a state of a sender of the object, wherein
the harmful degree determination step determines the harmful degree to the living organism of the object loaded in the moving body based on the sender state information acquired in the sender state acquisition step.

23. The method according to claim 21, further comprising a step of:
a transport plan creation step of creating a transport plan for the object based on the harmful degree of the object determined in the harmful degree determination step.

24. A non-transitory computer-readable storage medium storing a for transporting an object loaded in a moving body at a first point, the program configured to execute:
a transport object state acquisition process of acquiring transport object state information which is information on a state of the object loaded in the moving body; and
a harmful degree determination process of determining a harmful degree to a living organism of the object loaded in the moving body based on the transport object state information acquired in the object state acquisition process.

25. The non-transitory computer-readable storage medium according to claim 24, wherein the program is configured to execute:
a sender state acquisition process of acquiring sender state information which is information on a state of a sender of the object, wherein
the harmful degree determination process determines the harmful degree based on the sender state information acquired in the sender state acquisition process.

26. (canceled)

27. A harmfulness determination device, comprising:
a harmful degree determination unit configured to determine a harmful degree to a living organism of a transport object loaded in a moving body at a first point.
